(19) United States
(12) Patent Application Publication
(10) Pub. No.: US 2025/0269973 A1
(43) Pub. Date: Aug. 28, 2025

(54) SYSTEMS AND METHODS FOR PROPULSOR PARKING

(71) Applicant: BETA AIR LLC, South Burlington, VT (US)

(72) Inventors: Collin Freiheit, Burlington, VT (US); Nicholas Moy, South Burlington, VT (US)

(21) Appl. No.: 19/198,467

(22) Filed: May 5, 2025

Related U.S. Application Data
(63) Continuation-in-part of application No. 17/752,020, filed on May 24, 2022.

(51) Int. Cl. B64D 31/12; B64C 11/00; B64C 11/50

(52) U.S. Cl. CPC B64D 31/12; B64C 11/002; B64C 11/50

(57) ABSTRACT

A system for propulsor synchronization using electronic brakes is disclosed. The system includes a controller located in an aircraft configured to receive a first signal from a first propulsor sensor of a plurality of propulsor sensors, the first propulsor sensor configured to measure a first motion parameter of a first propulsor of a plurality of propulsors. The controller may receive a second signal from a second propulsor sensor of the plurality of propulsor sensors, the second propulsor sensor configured to measure a second motion parameter of a second propulsor of the plurality of propulsors. The controller may synchronously decelerate the first propulsor and the second propulsor based on the first motion parameter and the second motion parameter.

This application is a continuation in part of and claims priority to U.S. patent application Ser. No. 17/752,020, filed May 24, 2022, the entire contents of which are incorporated herein by reference.

### FIELD OF THE INVENTION

The present invention generally relates to the field of electric vehicles. In particular, the present invention is directed to systems and methods for propulsor parking.

### BACKGROUND

In electric multi-propulsion systems, such as electric vertical take-off and landing (eVTOL) aircraft, decelerating propulsors may cause drumming when not synchronized. At various points it may be desired to synchronously or asynchronously decelerate the propulsors to zero velocity.

### SUMMARY OF THE DISCLOSURE

In an aspect of the present disclosure is a system for propulsor synchronization, the system including a controller located in an aircraft configured to receive a first signal from a first propulsor sensor of a plurality of propulsor sensors, the first propulsor sensor configured to measure a first motion parameter of a first propulsor of a plurality of propulsors; receive a second signal from a second propulsor sensor of the plurality of propulsor sensors, the second propulsor sensor configured to measure a second motion parameter of a second propulsor of the plurality of propulsors; synchronously decelerate the first propulsor and the second propulsor based on the first motion parameter and the second motion parameter.

In another aspect of the present disclosure is a method for propulsor synchronization, the method including receiving, at a controller located in an aircraft, a first signal from a first propulsor sensor of a plurality of propulsor sensors, the first propulsor sensor configured to measure a first motion parameter of a first propulsor of a plurality of propulsors; receiving, at the controller, a second signal from a second propulsor sensor of the plurality of propulsor sensors, the second propulsor sensor configured to measure a second motion parameter of a second propulsor of the plurality of propulsors; and synchronously decelerating, by the controller, the first propulsor and the second propulsor based on the first motion parameter and the second motion parameter.

In another aspect of the present disclosure is a system for propulsor parking, the system including a controller configured to: receive a first signal from a first propulsor sensor configured to measure a rate of rotation of a propulsor; receive a second signal from a second propulsor sensor configured to measure an orientation of the propulsor; determine a trajectory associated with bringing the propulsor to a parked position, the trajectory corresponding to decelerating the rate of rotation of the propulsor to zero velocity and bringing the orientation of the propulsor to an ending orientation associated with the parked position; determine, based at least on the trajectory, control values to cause the propulsor to reach the parked position; and transmit a command to the propulsor, wherein the command is configured to cause the propulsor to implement the trajectory by simultaneously decelerating the rate of rotation of the propulsor to zero velocity and cause the propulsor to be oriented according to the ending orientation at the parked position.

In another aspect of the present disclosure is a method for parking propulsors of an aircraft, comprising: receiving, by a controller, a first signal from a first propulsor sensor configured to measure a rate of rotation of a propulsor; receiving, by the controller, a second signal from a second propulsor sensor configured to measure an orientation of the propulsor; determining, by the controller, a trajectory to bring the propulsor to a parked position, the trajectory corresponding to decelerating the rate of rotation of the propulsor to zero velocity and bringing the orientation of the propulsor to an ending orientation associated with the parked position; determining, based at least on the trajectory, control values to cause the propulsor to reach the parked position; and transmitting, by the controller, a command to the propulsor, wherein the command is configured to cause the propulsor to implement the trajectory by simultaneously decelerating the rate of rotation of the propulsor to zero velocity and causing the propulsor to be oriented according to the ending orientation at the parked position.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a cross-sectional view of an exemplary embodiment of a system for locking an electric propulsion system;

FIG. 2 is an exploded view of an exemplary motor according to an embodiment of the disclosure; FIG. 3 is a perspective view of a motor incorporated in an aircraft according to an embodiment of the disclosure;

FIG. 4 is a block diagram of a flight controller according to an embodiment of the disclosure;

FIG. 5 is a block diagram of a machine-learning process according to an embodiment in the present disclosure;

FIG. 6 is a block diagram of an exemplary control system according to an embodiment of the disclosure;

FIG. 7A is an illustration of an exemplary trajectory, according to an embodiment of the disclosure;

FIG. 7B is an illustration of an exemplary trajectory, according to an embodiment of the disclosure;

FIG. 8 is a flow chart of an exemplary embodiment of a method of use of the braking system in one or more aspects of the present disclosure;

FIG. 9 is a flow chart of an exemplary method for propulsor parking according to the techniques described herein; and

FIG. 10 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for propulsor synchronization. The system includes a controller in an aircraft configured to receive a signal from a first propulsor sensor of a plurality of propulsor sensors, the first propulsor sensor configured to measure a first motion parameter of a first propulsor of a plurality of propulsors. The controller may receive a signal from a second propulsor sensor of the plurality of propulsor sensors, the second propulsor sensor configured to measure a second motion parameter of a second propulsor of the plurality of propulsors. The controller may synchronously decelerate the first propulsor and the second propulsor based on the first motion parameter and the second motion parameter. The controller may allow the propulsor to slow at a desired rate for parking.

Additionally, aspects of the present disclosure are directed to systems and method for propulsor parking using a trajectory. The system includes a controller configured to receive a first signal from a first propulsor sensor configured to measure a rate of rotation of a propulsor. The controller may receive a second signal from a second propulsor sensor configured to measure an orientation of the propulsor. The controller may determine a trajectory associated with bringing the propulsor to a parked position, the trajectory corresponding to decelerating the rate of rotation of the propulsor to zero velocity and bringing the orientation of the propulsor to an ending orientation associated with the parked position. The controller may determine, based at least on the trajectory, control values to cause the propulsor to reach the parked position. The controller may transmit a command to the propulsor, wherein the command is configured to cause the propulsor to implement the trajectory by simultaneously decelerating the rate of rotation of the propulsor to zero velocity and cause the propulsor to be oriented according to the ending orientation at the parked position.

Exemplary embodiments illustrating aspects of the present disclosure are described below in the context of several specific examples.

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

In the following description, for the purposes of explanation, numerous specific details are set forth in order to provide a thorough understanding of the present invention. For purposes of description herein, relating terms, including “upper,” “lower,” “left,” “rear,” “right,” “front,” “top,” “bottom,” “up,” “down,” “vertical,” “horizontal,” “forward,” “backward” and derivatives thereof relate to embodiments oriented as shown for exemplary purposes in FIG. 3.

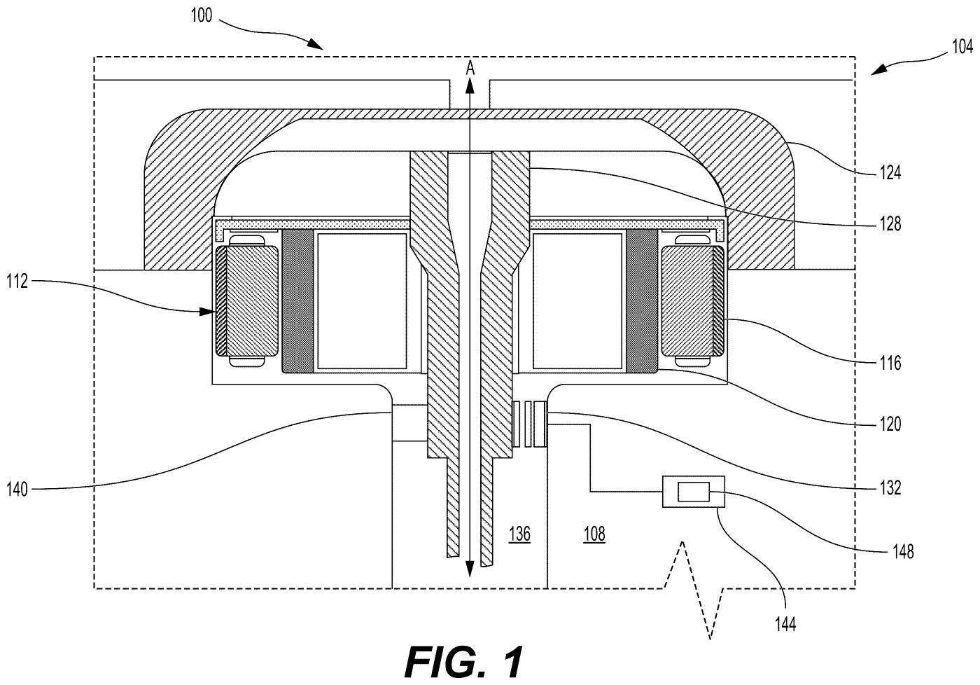

Now referring to FIG. 1, a cross-section view of an exemplary embodiment of a propulsor system is illustrated. System 100 may include a propulsor 104 configured to propel an aircraft 108. Aircraft 108 may be an aircraft powered by one or more electric motors 112a-n. Aircraft 108 may be an aircraft 300 shown in FIG. 3. Aircraft 108 may include electrical vertical takeoff and landing (eVTOL) aircraft, helicopter, unmanned aerial vehicles (UAVs), drones, rotorcraft, commercial aircraft, and/or the like. Aircraft 108 may be configured for fixed-wing landing and/or vertical, rotor-based, landing. Aircraft 108 may include one or more components that generate lift, including without limitation wings, airfoils, rotors, propellers, jet engines, or the like, or any other component or feature that an aircraft may use for mobility during flight. A “propulsor”, as used in this disclosure, is a component or device used to propel a craft by exerting force on a fluid medium, which may include a gaseous medium such as air or a liquid medium such as water. Propulsor 104 may include one or more propulsive devices.

Propulsor 104 may include at least a lift propulsor. In an embodiment, aircraft 108 may include a thrust element. Front propulsors and/or rear propulsors of propulsor 104 may each be lift propulsors. A thrust element may include any device or component that converts the mechanical energy of a motor, for instance in the form of rotational motion of a shaft, into thrust in a fluid medium. For example, a thrust element may include without limitation a marine propeller or screw, an impeller, a turbine, a pump-jet, a paddle or paddle-based device, or the like. Persons skilled in the art, upon reviewing the entirety of this disclosure, would appreciate, after having read the entirety of this disclosure, that various devices that may be used as at least a thrust element. As used herein, a propulsive device may include, without limitation, a device using moving or rotating foils, including without limitation one or more rotors, an airscrew or propeller, a set of airscrews or propellers such as contra-rotating propellers, a moving or flapping wing, or the like. In an embodiment, propulsor 104 may include at least a blade. Persons skilled in the art, upon reviewing the entirety of this disclosure, will be aware of various devices that may be used as propulsor 104. In an embodiment, when a propulsor twists and pulls air behind it, it will, at the same time, push the aircraft forward with an equal amount of force. In an embodiment, when a propulsor twists and pulls air bellow it, it will, at the same time, push the aircraft upward with an equal amount of force. In an embodiment, thrust element may include a helicopter rotor incorporated into propulsor 104. A helicopter rotor, as used herein, may include one or more blade or wing elements driven in a rotary motion to drive fluid medium in a direction axial to the rotation of the blade or wing element. Its rotation is due to the interaction between the windings and magnetic fields which produces a torque around the rotor's axis. A helicopter rotor may include a plurality of blade or wing elements.

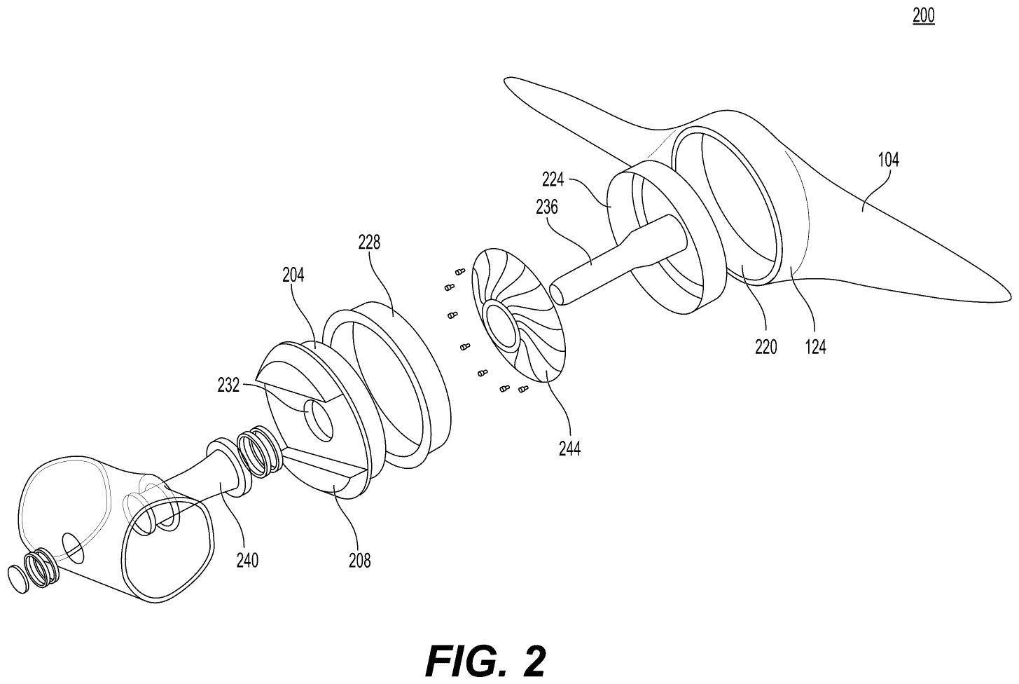

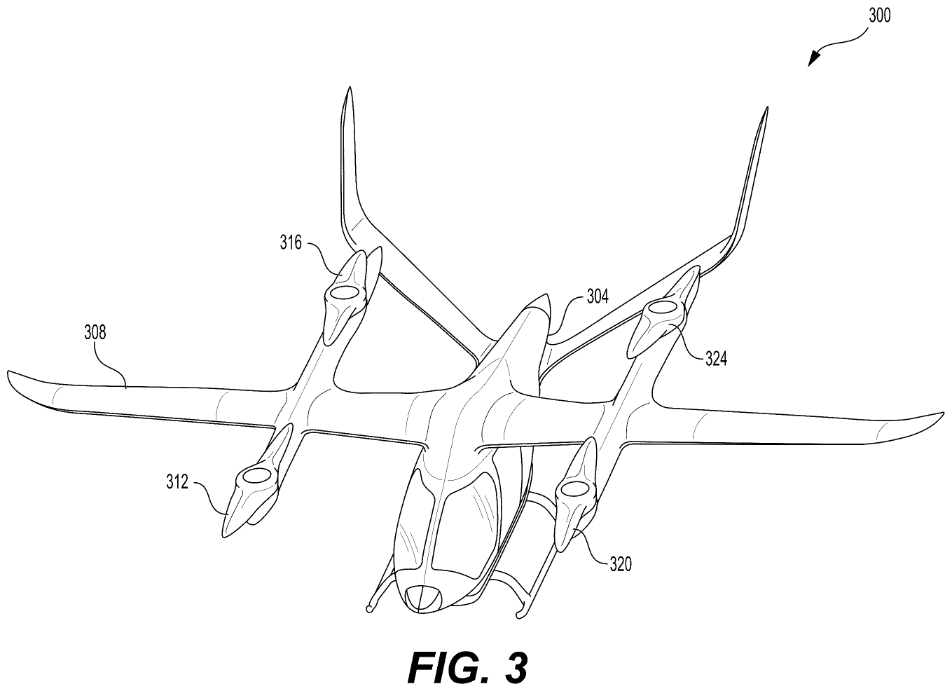

With continued reference to FIG. 1, system 100 may include a motor 112 operatively connected to propulsor 104. Motor 112 may be configured to rotate propulsor 104. As used in this disclosure, “motor” is a device, such as an electric motor, that converts electrical energy into mechanical energy, for instance by causing a shaft to rotate. An electric motor may be driven by direct current (DC) electric power. As an example and without limitation, an electric motor may include a brushed DC electric motor or the like. An electric motor may be, without limitation, driven by electric power having varying or reversing voltage levels, such as alternating current (AC) power as produced by an alternating current generator and/or inverter, or otherwise varying power, such as produced by a switching power source. An electric motor may include, for example and without limitation, brushless DC electric motors, permanent magnet synchronous an electric motor, switched reluctance motors, or induction motors. In addition to inverter and/or a switching power source, a circuit driving an electric motor may include electronic speed controllers (not shown) or other components for regulating motor speed, rotation direction, and/or dynamic braking. Motor(s) 112 may be used in an electric vehicle such as an electric automobile and/or an electric aircraft, including an electrical vertical takeoff and landing (eVTOL) aircraft, a helicopter, a commercial aircraft, an unmanned aerial vehicle, a rotorcraft, and the like. Motor 112 may include the exemplary embodiment of motor 200 discussed in reference to FIG. 2. Motor 112 may be consistent with disclosure of motor in U.S. patent application Ser. No. 17/563,498 filed on Dec. 28, 2021 and titled “AN AIRCRAFT LIFT MOTOR WITH AIR COOLING”, which is incorporated by reference herein in its entirety.

Still referring to FIG. 1, motor 112 may include a stator 116. As used in this disclosure, a “stator” is a stationary component of a motor and/or motor assembly. In an embodiment, stator 116 may include at least first magnetic element. As used herein, first magnetic element is an element that generates a magnetic field. For example, first magnetic element may include one or more magnets which may be assembled in rows along a structural casing component. Further, first magnetic element may include one or more magnets having magnetic poles oriented in at least a first direction. The magnets may include at least a permanent magnet. Permanent magnets may be composed of, but are not limited to, ceramic, alnico, samarium cobalt, neodymium iron boron materials, any rare earth magnets, and the like. Further, the magnets may include an electromagnet. As used herein, an electromagnet is an electrical component that generates magnetic field via induction; the electromagnet may include a coil of electrically conducting material, through which an electric current flow to generate the magnetic field, also called a field coil or field winding. A coil may be wound around a magnetic core, which may include without limitation an iron core or other magnetic material. The core may include a plurality of steel rings insulated from one another and then laminated together; the steel rings may include slots in which the conducting wire will wrap around to form a coil. First magnetic element may act to produce or generate a magnetic field to cause other magnetic elements to rotate, as described in further detail below. Stator 116 may include a frame to house components including first magnetic element, as well as one or more other elements or components as described in further detail below. In an embodiment, a magnetic field may be generated by first magnetic element and can include a variable magnetic field. In embodiments, a variable magnetic field may be achieved by use of an inverter, a controller, or the like. In an embodiment, stator 116 may have an inner and outer cylindrical surface; a plurality of magnetic poles may extend outward from the outer cylindrical surface of the stator 116. In an embodiment, stator 116 may include an annular stator, wherein the stator is ring-shaped. In an embodiment, stator 116 may be incorporated into a DC motor where stator is fixed and functions to supply the magnetic fields where a corresponding rotor, as described in further detail below, rotates. In an embodiment, stator 116 may be incorporated in an AC motor where stator 116 is fixed and functions to supply the magnetic fields by radio frequency electric currents through an electromagnet to a corresponding rotor, as described in further detail below, rotates.

Motor 112 may include a rotor 120 coaxial within stator 116. As used in this disclosure, a “rotor” is a portion of an electric motor that rotates with respect to a stator of the electric motor. Rotor 120 may include a second magnetic element, which may include one or more magnetic elements. Stator 116 may be configured to rotate rotor 120. For example, stator 116 may be configured to generate a magnetic field from first magnetic element in stator 116 to cause second magnetic element in rotor 120, and thus the rotor 120, to rotate around a central axis A Rotor 120 may be connected to propulsor 104. In some embodiments, rotor 120 may be integrated into propulsor 104. Propulsor 104, such as a hub 124 of the propulsor 104, may to attached to a rotor shaft 128 of rotor 120. A rotation of rotor 120 may cause propulsor 104 to also rotate around central axis A, which may translate into propulsion such as lift and/or thrust. In some embodiments, rotor 120 may be mechanically connected to propulsor 104 by at least a gear, such as a gearbox, wherein one rotation of the rotor 120 may cause less than one rotation, one rotation, or more than one rotation of the propulsor 104.

System 100 includes at least a propulsor sensor 132 configured to determine a motion parameter of propulsor 104. As used in this disclosure, a “propulsor sensor” is a device that is configured to detect an input and/or a phenomenon pertaining to a propulsor 104 and generate a signal related to the detection. Propulsor sensor 132 may include one or more sensors. For example, and without limitation, propulsor sensor 132 may transduce a detected motion parameter of propulsor 104. As used in this disclosure, a “motion parameter” is a numerical or other measurable factor pertaining to a movement and/or a position of a propulsor. Motion parameter may include a rate of rotation of propulsor 104 (such as an angular speed or angular velocity) and/or a position of propulsor 104, such as a position of one or more blades on the propulsor 104. Propulsor sensor 132 may include an angular position sensor such as an encoder or Hall effect sensor. In some embodiments, propulsor sensor 132 may include other sensors, such as a magnetic proximity sensor, inductive proximity sensor, displacement sensor, light sensor, position sensor, and/or the like. A “Hall effect sensor,” for the purposes of this disclosure is a sensor that detects the presence and magnitude of a magnetic field using the Hall effect. In some embodiments, a Hall effect sensor may be used to detect the position of rotor 120 and/or rotor shaft 128. The encoder may be a rotary encoder. For the purposes of this disclosure, a “rotary encoder” is an electro-mechanical device that senses angular position by tracking the position or motion of an axle. In some embodiments, the rotary encoder may be an absolute rotary encoder. For the purposes of this disclosure, an “absolute rotary encoder” is a rotary encoder that is able to track an absolute position of the object that it is tracking. In some embodiments, the rotary encoder may be an “incremental rotary encoder” which, for the purposes of this disclosure, is a rotary encoder that tracks changes in position rather than absolute position. Encoders may include mechanical encoders, optical encoders, magnetic encoders, capacitive encoders, multi-tum encoders, and the like. Propulsor sensor 132 may be located on stator 116, rotor 120, rotor shaft 128, an interior surface of a cavity 136 that motor 112 may be disposed or recessed within, such as a boom, and/or any component of aircraft 108 conducive to the propulsor sensor 132 being positioned to measure motion parameter. Propulsor sensor 132 may include a plurality of propulsor sensors 132. Propulsor sensor 132 may include a proximity sensor, such as any proximity sensor discussed above, and proximity sensor target.

Each proximity sensor may be on a component of aircraft 108 near a corresponding propulsor 104 that remains stationary in relation to the aircraft 108, such as stator 116, a boom of the aircraft 108, and/or any other component of the aircraft 108. Each proximity sensor target may be on a corresponding rotor 120, rotor shaft 128, propulsor 104, and/or any other component of aircraft 108 that rotates with the propulsor 104 about central axis A Propulsor sensor 132 may be consistent with disclosure of propulsor sensor in U.S. patent application Ser. No. 17/734,023 filed on Apr. 30, 2022 and titled “SYSTEMS AND METHODS FOR LOCKING AN ELECTRIC PROPULSION SYSTEM”, which is incorporated by reference herein in its entirety.

With continued reference to FIG. 1, system 100 may include a braking module 140 and system 100 includes a controller 144 in aircraft 108. Controller 144 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Controller 144 may include a single computing device operating independently, or may include two or more computing device operating in concert, in parallel, sequentially or the like; two or more computing devices may be included together in a single computing device or in two or more computing devices. Controller 144 may interface or communicate with one or more additional devices as described below in further detail via a network interface device. Network interface device may be utilized for connecting controller 144 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Controller 144 may include but is not limited to, for example, a computing device or cluster of computing devices in a first location and a second computing device or cluster of computing devices in a second location. Controller 144 may include one or more computing devices dedicated to data storage, security, distribution of traffic for load balancing, and the like. Controller 144 may distribute one or more computing tasks as described below across a plurality of computing devices of computing device, which may operate in parallel, in series, redundantly, or in any other manner used for distribution of tasks or memory between computing devices. Controller 144 may be implemented using a “shared nothing” architecture in which data is cached at the worker, in an embodiment, this may enable scalability of system 100 and/or computing device. Controller 144 may include a flight controller as described in this disclosure.

With continued reference to FIG. 1, controller 144 may be designed and/or configured to perform any method, method step, or sequence of method steps in any embodiment described in this disclosure, in any order and with any degree of repetition. For instance, controller 144 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Controller 144 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing. Controller 144 may include a flight controller as described in this disclosure.

Controller 144 may be communicatively connected to propulsor sensor 132. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. Controller 144 may be configured to receive a signal from propulsor sensor 132 based on a corresponding motion parament of propulsor 104 determined by the propulsor sensor 132.

System 100 may include at least a braking module 140. Braking module 140 may be configured to decelerate a rate of rotation of propulsor 104. Braking module 140 may include a plurality of braking modules 140. Each propulsor 104 may be mechanically connected to a corresponding braking module 140. Braking module 140 may be configured to control a deceleration of a rate of rotation of each propulsor 104. For example, braking module 140 may be configured to decelerate a rate of rotation of propulsor 104 at a specified deceleration rate. Braking module 140 may be configured to maintain deceleration of a rate of rotation of propulsor 104 within a specified range. Braking module 140 may be configured to prevent propulsor 104 from exceeding a predetermined threshold of deceleration by reducing and/or stopping the braking when the threshold is reached. Braking module 140 may include at least an electronic brake.

In some embodiments, braking module 140 may include a first braking pad on rotor 120, rotor shaft 128, propulsor 104, and/or hub 124, and a second braking pad configured to press against first braking pad. Second braking pad may be on cavity 136, stator 116, a boom of aircraft 108, and/or other component of aircraft 108. A plunger may be configured to press second braking pad against first braking pad as the plunger extends from the coil. In some embodiments, the braking module 140 may be configured to lock propulsor 104 and prevent a movement of the propulsor 104. For example, the braking module 140 may be configured to gradually increase the pressure between first braking pad and second braking pad to slow a rate of rotation of propulsor 104 at a controlled rate and eventually lock the propulsor 104. Deceleration of propulsors 104 may include any system or method of propeller parking as described in U.S. Nonprovisional application Ser. No. 17/732,774, filed on Apr. 29, 2022, and entitled “A SYSTEM FOR PROPELLER PARKING CONTROL FOR AN AIRCRAFT AND A METHOD FOR ITS USE,” the entirety of which is incorporated herein by reference. Engagement of the braking module 140 may be based on a rotational rate of propulsor 104.

Still referring to FIG. 1, braking module 140 may be configured to perform dynamic braking. “Dynamic braking” as used in this disclosure means using at least a motor to resist a motion. A motor, such as motor 112, which may be configured to convert electrical energy to mechanical energy of a rotating shaft may be understood as an inverse of converting the mechanical energy of the rotating shaft to electrical energy. Both mechanical-to-electrical and electrical-to-mechanical conversions may be accomplished with an interaction of an armature with a moving magnetic field; where, the armature is connected to an electrical circuit acting either as a power supply to induce motion or a power receptor to resist motion. In some embodiments, motor 112 may be used to resist motion by switching from a supply circuit to a receptor circuit, while generating a magnetic field, for example by applying electric current to field coils that generate the magnetic field. An amount of resistance applied to a rotating rotor shaft 128 by motor 112 when dynamically braking is related to a rate of electrical power generation plus some efficiency loss. In some cases, rate of electrical power generation may be proportional to a strength of magnetic field, controlled for example by current in field coils, and a rate at which an armature and magnetic field rotate relative one another, which is proportional to a rotational velocity of rotor shaft 128. In some cases, an amount of braking power may be controlled by varying a strength of magnetic field, for example by varying current at filed coils. As a rate of electrical power generation and braking power, are proportional to a rotational velocity of a drive shaft, a stronger magnetic field may be required to maintain braking power as the rotational velocity speed. In some embodiments, there is a lower limit at which dynamic braking may be effective depending on current available for application to field coils. In some cases, an electric motor being used to slow or arrest a rotational movement may be referred to as regenerative braking, when generated electrical energy is stored, for example by a battery, or as rheostatic braking, when generated electrical energy is dissipated, for example by way of one or more resistors. In some cases, a permanent magnet motor may be controlled to resist rotational motion by shorting out two electrical terminals powering the permanent magnet motor. In this case, permanent magnet motor will dissipate all generated energy as heat.

With continued reference to FIG. 1, braking module 140 may include at least an electronic brake. As used in this disclosure, an “electronic brake” is an electronically actuated braking system. An electronic brake may include any of the braking components discussed above; for example, the first braking pad and the second braking pad. In some embodiments, braking module 140 may include an actuator. As a non-limiting example, the electronic brake may include an actuator in order to provide actuation, for example, of the first braking pad and/or second braking pad. The actuator may be communicatively connected to controller 144.

With continued reference to FIG. 1, an actuator may include a component of a machine that is responsible for moving and/or controlling a mechanism or system. An actuator may, in some cases, require a control signal and/or a source of energy or power. In some cases, a control signal may be relatively low energy. Exemplary control signal forms include electric potential or current, pneumatic pressure or flow, or hydraulic fluid pressure or flow, mechanical force/torque or velocity, or even human power. In some cases, an actuator may have an energy or power source other than control signal. This may include a main energy source, which may include for example electric power, hydraulic power, pneumatic power, mechanical power, and the like. In some cases, upon receiving a control signal, an actuator responds by converting source power into mechanical motion. In some cases, an actuator may be understood as a form of automation or automatic control.

With continued reference to FIG. 1, in some embodiments, actuator may include a hydraulic actuator. A hydraulic actuator may consist of a cylinder or fluid motor that uses hydraulic power to facilitate mechanical operation. Output of hydraulic actuator may include mechanical motion, such as without limitation linear, rotatory, or oscillatory motion. In some cases, hydraulic actuator may employ a liquid hydraulic fluid. As liquids, in some cases. are incompressible, a hydraulic actuator can exert large forces. Additionally, as force is equal to pressure multiplied by area, hydraulic actuators may act as force transformers with changes in area (e.g., cross sectional area of cylinder and/or piston). An exemplary hydraulic cylinder may consist of a hollow cylindrical tube within which a piston can slide. In some cases, a hydraulic cylinder may be considered single acting. “Single acting” may be used when fluid pressure is applied substantially to just one side of a piston. Consequently, a single acting piston can move in only one direction. In some cases, a spring may be used to give a single acting piston a return stroke. In some cases, a hydraulic cylinder may be double acting. “Double acting” may be used when pressure is applied substantially on each side of a piston; any difference in resultant force between the two sides of the piston causes the piston to move.

With continued reference to FIG. 1, in some embodiments, actuator may include a pneumatic actuator. In some cases, a pneumatic actuator may enable considerable forces to be produced from relatively small changes in gas pressure. In some cases, a pneumatic actuator may respond more quickly than other types of actuators, for example hydraulic actuators. A pneumatic actuator may use compressible flued (e.g., air). In some cases, a pneumatic actuator may operate on compressed air. Operation of hydraulic and/or pneumatic actuators may include control of one or more valves, circuits, fluid pumps, and/or fluid manifolds.

With continued reference to FIG. 1, in some cases, actuator may include an electric actuator. Electric actuator may include any of electromechanical actuators, linear motors, and the like. In some cases, actuator may include an electromechanical actuator. An electromechanical actuator may convert a rotational force of an electric rotary motor into a linear movement to generate a linear movement through a mechanism. Exemplary mechanisms, include rotational to translational motion transformers, such as without limitation a belt, a screw, a crank, a cam, a linkage, a scotch yoke, and the like. In some cases, control of an electromechanical actuator may include control of electric motor, for instance a control signal may control one or more electric motor parameters to control electromechanical actuator. Exemplary non-limitation electric motor parameters include rotational position, input torque, velocity, current, and potential. electric actuator may include a linear motor. Linear motors may differ from electromechanical actuators, as power from linear motors is output directly as translational motion, rather than output as rotational motion and converted to translational motion. In some cases, a linear motor may cause lower friction losses than other devices. Linear motors may be further specified into at least 3 different categories, including flat linear motor, U-channel linear motors and tubular linear motors. Linear motors may controlled be directly controlled by a control signal for controlling one or more linear motor parameters. Exemplary linear motor parameters include without limitation position, force, velocity, potential, and current.

With continued reference to FIG. 1, in some embodiments, an actuator may include a mechanical actuator. In some cases, a mechanical actuator may function to execute movement by converting one kind of motion, such as rotary motion, into another kind, such as linear motion. An exemplary mechanical actuator includes a rack and pinion. In some cases, a mechanical power source, such as a power take off may serve as power source for a mechanical actuator. Mechanical actuators may employ any number of mechanism, including for example without limitation gears, rails, pulleys, cables, linkages, and the like.

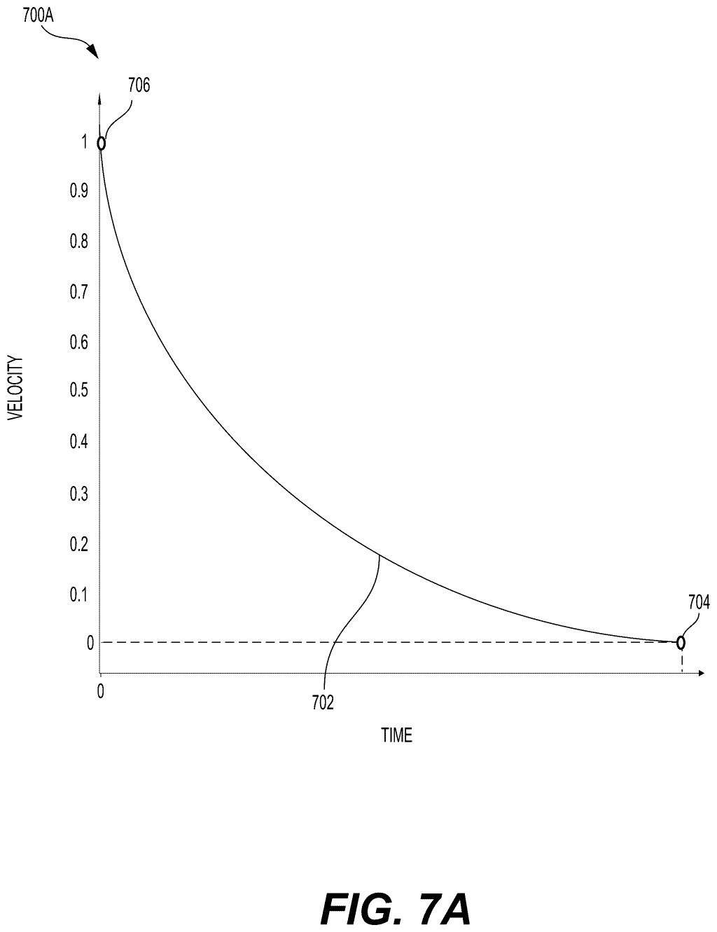

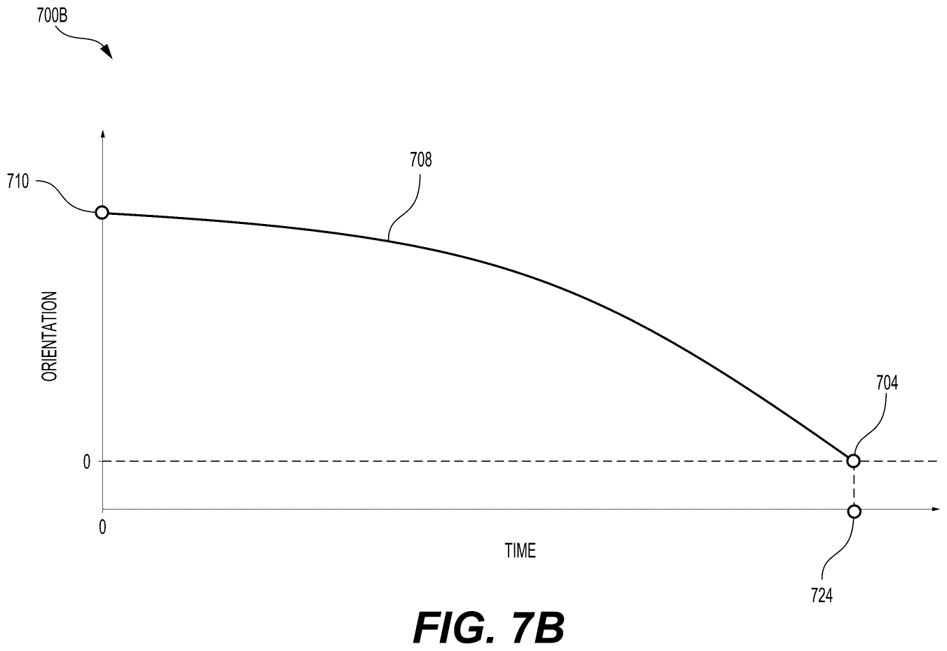

With continued reference to FIG. 1, an amount of force applied to propulsor 104 by electronic brake may be based on following a desired trajectory (e.g., such as predetermined trajectory, resulting in the calculation of a velocity trajectory and/or a position trajectory) of propulsor 104. Trajectories (e.g., velocity trajectory and/or position trajectory) are discussed further with reference to FIGS. 7A and 7B. In some embodiments, electronic brake may be configured to apply a constant force to propulsor 104. While electronic brake applies a constant force to propulsor 104, the braking may be selectively overcome by a positive torque from motor 112. For the purposes of this disclosure, a “positive torque” is a torque that is applied in the direction opposite the direction that the braking module of the propulsor acts in. For example, this may be done to match the velocity trajectory of propulsor 104. Controller 144 may be configured to control an amount of braking from braking module 140 applied to propulsor 104 and an amount of torque applied to the propulsor 104 from motor 112 to control a resulting deceleration rate of the propulsor 104. In some embodiments, controller 144 may allow force from braking module 140 to gradually overcome torque from motor 112 to gradually decelerate propulsor 104. Controller 144 may determine an amount of force to be applied to propulsor 104 by braking module and/or an amount of torque to be applied to the propulsor 104 by motor 112 based on one or more tables including an amount of braking force and/or an amount of torque to be applied to the propulsor 104 to achieve a given deceleration rate.

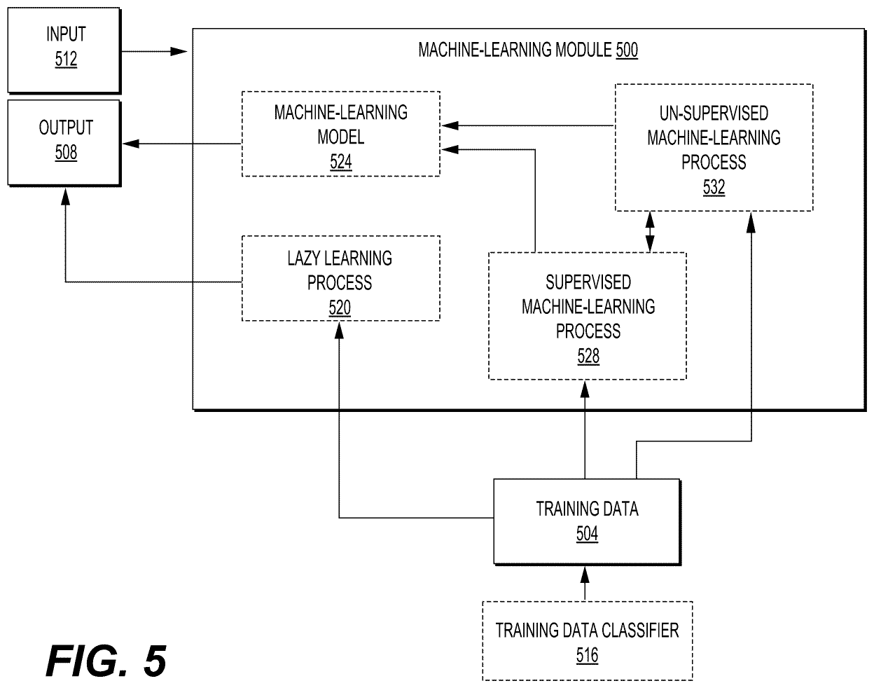

Still referring to FIG. 1, controller 144 may determine an amount of braking to apply to propulsor 104 from braking module 140 and/or an amount of torque to apply to the propulsor 104 from motor 112 by utilizing one or more algorithms or generating one or more machine-learning models using a machine learning module, such as machine-learning module 148. The machine learning models may be configured to output the amount of braking and/or torque to apply to the propulsor 104. Machine-learning module 148 may include utilizing a classifier and/or a machine-learning model as discussed in reference to FIG. 5. In one or more embodiments, machine-learning module 148 may be generated using training data. Training data may include inputs and corresponding predetermined outputs so that machine-learning module 148 may use the correlations between the provided exemplary inputs and outputs to develop an algorithm and/or relationship that then allows machine-learning module 148 to determine its own outputs for inputs. Training data may contain correlations that a machine-learning process may use to model relationships between two or more categories of data elements. The exemplary inputs and outputs may come from a database, such as a deceleration database, or be provided by a user such as a pilot. In other embodiments, machine-learning module 148 may obtain a training set by querying a communicatively connected database that includes past inputs and outputs. Training data may include inputs from various types of databases, resources, and/or user inputs and outputs correlated to each of those inputs so that a machine-learning module may determine an output. Correlations may indicate causative and/or predictive links between data, which may be modeled as relationships, such as mathematical relationships, by machine-learning processes, as described in further detail below. Machine-learning model may be generated using training data. Machine-learning model may be trained by the correlated inputs and outputs of training data. Inputs of training data may include deceleration rates, desired trajectories, calculated trajectories, etc. Outputs of training data may include braking forces applied by braking module 140 to propulsor 104 and/or torque from motor 112 applied to the propulsor 104 that resulted in the corresponding deceleration rates or trajectories. Training data may include braking forces applied by braking module 140 and/or torque from motor 112 and the resulting deceleration of propulsor 104 that have already been determined and/or measured whether manually, by machine, or any other method. Training data may include previous outputs such that machine-learning module 148 iteratively produces outputs, thus creating a feedback loop for machine-learning module 148 to learn from previous iterations. Machine-learning module 148 using a machine-learning process may output an amount of braking force by braking module 140 and/or an amount of torque applied by motor 112 based on input of desired deceleration rate and training data.

Referring now to FIG. 2, an exemplary embodiment of a motor 200 is illustrated. Motor 200 may include at least a stator 204. Stator 204, as used herein, is a stationary component of a motor and/or motor assembly. In an embodiment, stator 204 may include at least first magnetic element 208. As used herein, first magnetic element 208 is an element that generates a magnetic field. For example, first magnetic element 208 may include one or more magnets which may be assembled in rows along a structural casing component. Further, first magnetic element 208 may include one or more magnets having magnetic poles oriented in at least a first direction. The magnets may include at least a permanent magnet. Permanent magnets may be composed of, but are not limited to, ceramic, alnico, samarium cobalt, neodymium iron boron materials, any rare earth magnets, and the like. Further, the magnets may include an electromagnet. As used herein, an electromagnet is an electrical component that generates magnetic field via induction; the electromagnet may include a coil of electrically conducting material, through which an electric current flow to generate the magnetic field, also called a field coil of field winding. A coil may be wound around a magnetic core, which may include without limitation an iron core or other magnetic material. The core may include a plurality of steel rings insulated from one another and then laminated together; the steel rings may include slots in which the conducting wire will wrap around to form a coil. First magnetic element 208 may act to produce or generate a magnetic field to cause other magnetic elements to rotate, as described in further detail below. Stator 204 may include a frame to house components including first magnetic element 208, as well as one or more other elements or components as described in further detail below. In an embodiment, a magnetic field may be generated by first magnetic element 208 and can include a variable magnetic field. In embodiments, a variable magnetic field may be achieved by use of an inverter, a controller, or the like. In an embodiment, stator 204 may have an inner and outer cylindrical surface; a plurality of magnetic poles may extend outward from the outer cylindrical surface of the stator. In an embodiment, stator 204 may include an annular stator, wherein the stator is ring-shaped. In an embodiment, stator 204 is incorporated into a DC motor where stator 204 is fixed and functions to supply the magnetic fields where a corresponding rotor, as described in further detail below, rotates. In an embodiment, stator 204 may be incorporated an AC motor where stator 204 is fixed and functions to supply the magnetic fields by radio frequency electric currents through an electromagnet to a corresponding rotor, as described in further detail below, rotates.

Still referring to FIG. 2, motor 200 may include propulsor 104. In embodiments, propulsor 104 may include an integrated rotor. As used herein, a rotor is a portion of an electric motor that rotates with respect to a stator of the electric motor, such as stator 204. A propulsor, as used herein, is a component or device used to propel a craft by exerting force on a fluid medium, which may include a gaseous medium such as air or a liquid medium such as water. Propulsor 104 may be any device or component that consumes electrical power on demand to propel an aircraft or other vehicle while on ground and/or in flight. Propulsor 104 may include one or more propulsive devices. In an embodiment, propulsor 104 may include a thrust element which may be integrated into the propulsor. A thrust element may include any device or component that converts the mechanical energy of a motor, for instance in the form of rotational motion of a shaft, into thrust in a fluid medium. For example, a thrust element may include without limitation a marine propeller or screw, an impeller, a turbine, a pump-jet, a paddle or paddle-based device, or the like. As another non-limiting example, at least a propulsor may include an eight-bladed pusher propeller, such as an eight-bladed propeller mounted behind the engine to ensure the drive shaft is in compression.

Persons skilled in the art, upon reviewing the entirety of this disclosure, will be aware of various devices that may be used as at least a thrust element. As used herein, a propulsive device may include, without limitation, a device using moving or rotating foils, including without limitation one or more rotors, an airscrew or propeller, a set of airscrews or propellers such as contra-rotating propellers, a moving or flapping wing, or the like. In an embodiment, propulsor 104 may include at least a blade. Persons skilled in the art, upon reviewing the entirety of this disclosure, will be aware of various devices that may be used as propulsor 104. In an embodiment, when a propulsor twists and pulls air behind it, it will, at the same time, push the aircraft forward with an equal amount of force. The more air pulled behind the aircraft, the more the aircraft is pushed forward. In an embodiment, thrust element may include a helicopter rotor incorporated into propulsor 104. A helicopter rotor, as used herein, may include one or more blade or wing elements driven in a rotary motion to drive fluid medium in a direction axial to the rotation of the blade or wing element. Its rotation is due to the interaction between the windings and magnetic fields which produces a torque around the rotor's axis. A helicopter rotor may include a plurality of blade or wing elements.

Continuing to refer to FIG. 2, in an embodiment, propulsor 104 may include hub 124 rotatably mounted to stator 204. Rotatably mounted, as described herein, is functionally secured in a manner to allow rotation. Hub 124 is a structure which allows for the mechanically coupling of components of the integrated rotor assembly. In an embodiment, hub 124 can be mechanically coupled to propellers or blades. In an embodiment, hub 124 may be cylindrical in shape such that it may be mechanically joined to other components of the rotor assembly. Hub 124 may be constructed of any suitable material or combination of materials, including without limitation metal such as aluminum, titanium, steel, or the like, polymer materials or composites, fiberglass, carbon fiber, wood, or any other suitable material. Hub 124 may move in a rotational manner driven by interaction between stator and components in the rotor assembly. Persons skilled in the art, upon reviewing the entirety of this disclosure, will be aware of various structures that may be used as or included as hub 124, as used and described herein.

Still referring to FIG. 2, in an embodiment, propulsor 104 and/or rotor shaft 236 may include second magnetic element 220, which may include one or more further magnetic elements. Second magnetic element 220 generates a magnetic field designed to interact with first magnetic element 208. Second magnetic element 220 may be designed with a material such that the magnetic poles of at least a second magnetic element are oriented in an opposite direction from first magnetic element 208. In an embodiment, second magnetic element 220 may be affixed to hub 124, rotor shaft 236, or another rotating or stationary electric motor component disclosed herein. Affixed, as described herein, is the attachment, fastening, connection, and the like, of one component to another component. For example, and without limitation, affixed may include bonding the second magnetic element 220 to hub 124, such as through hardware assembly, spot welding, riveting, brazing, soldering, glue, and the like. Second magnetic element 220 may include any magnetic element suitable for use as first magnetic element 208. For instance, and without limitation, second magnetic element may include a permanent magnet and/or an electromagnet. Second magnetic element 220 may include magnetic poles oriented in a second direction opposite, in whole or in part, of the orientation of the poles of first magnetic element 208. In an embodiment, motor 200 may include a motor assembly incorporating stator 204 with a first magnet element and second magnetic element

220. First magnetic element 208 may include magnetic poles oriented in a first direction, a second magnetic element includes a plurality of magnetic poles oriented in the opposite direction than the plurality of magnetic poles in the first magnetic element 208.

Referring again to FIG. 2, in an embodiment, first magnetic element 208 may be a productive element, defined herein as an element that produces a varying magnetic field. Productive elements may produce magnetic field that may attract and other magnetic elements, possibly including a receptive element. Second magnetic element may be a productive or receptive element. A receptive element may react due to the magnetic field of first magnetic element 208. In an embodiment, first magnetic element 208 may produce a magnetic field according to magnetic poles of first magnetic element 208 oriented in a first direction. Second magnetic element 220 may produce a magnetic field with magnetic poles in the opposite direction of the first magnetic field, which may cause the two magnetic elements to attract one another. Receptive magnetic element may be slightly larger in diameter than the productive element. Interaction of productive and receptive magnetic elements may produce torque and cause the assembly to rotate. Hub 124 and rotor assembly may both be cylindrical in shape where rotor may have a slightly smaller circumference than hub 124 to allow the joining of both structures. Coupling of hub 124 to stator 204 may be accomplished via a surface modification of either hub 124, stator 204 or both to form a locking mechanism. Coupling may be accomplished using additional nuts, bolts, and/or other fastening apparatuses. In an embodiment, an integrated rotor assembly as described above may reduce profile drag in forward flight for an aircraft. Profile drag may be caused by a number of external forces that the aircraft is subjected to. In an embodiment, incorporating propulsor 104 into hub 124, may reduce a profile of motor 200 resulting in a reduced profile drag. In an embodiment, the rotor, which may include motor inner magnet carrier 224, motor outer magnet carrier 228, propulsor 104 may be incorporated into hub 124. In an embodiment, inner motor magnet carrier 224 may rotate in response to a magnetic field. The rotation may cause hub 124 to rotate. This unit may be inserted into motor 200 as one unit. This may enable ease of installation, maintenance, and removal.

Still referring to FIG. 2, stator 204 may include through-hole 232. Through-hole 232 may provide an opening for a component to be inserted through to aid in attaching propulsor with integrated rotor and rotor shaft to stator. In an embodiment, through-hole 232 may have a round or cylindrical shape and be located at a rotational axis of stator 204, which in an embodiment may be similar to or the same as axis of rotation 212. Hub 124 may be mounted to stator 204 by means of rotor shaft 236 rotatably inserted though through-hole 232. The rotor shaft 236 may be mechanically coupled to stator 204 such that rotor shaft 236 is free to rotate about its centerline axis, which may be effectively parallel and coincident to stator's centerline axis, and further the rotor shaft and stator may include a void of empty space between them, where at least a portion the outer cylindrical surface of the rotor shaft is not physically contacting at least a portion of the inner cylindrical surface of the stator. This void may be filled, in whole or in part, by air, a vacuum, a partial vacuum or other gas or combination of gaseous elements and/or compounds, to name a few. Through-hole 232 may have a diameter that is slightly larger than a diameter of rotor shaft 236 to allow rotor shaft 236 to fit through through-hole 232 to connect stator 204 to hub 124. Rotor shaft 236 may rotate in response to rotation of propulsor 104.

Still referring to FIG. 2, motor 200 may include a bearing cartridge 240. Bearing cartridge 240 may include a bore. Rotor shaft 236 may be inserted through the bore of bearing cartridge 240. Bearing cartridge 240 may be attached to a structural element of a vehicle. Bearing cartridge 240 functions to support the rotor and to transfer the loads from the motor. Loads may include, without limitation, weight, power, magnetic pull, pitch errors, out of balance situations, and the like. Bearing cartridge 240 may include a bore. Bearing cartridge 240 may include a smooth metal ball or roller that rolls against a smooth inner and outer metal surface. The rollers or balls take the load, allowing the device to spin. a bearing may include, without limitation, a ball bearing, a straight roller bearing, a tapered roller bearing or the like. Bearing cartridge 240 may be subject to a load which may include, without limitation, a radial or a thrust load. Depending on the location of bearing cartridge 240 in the assembly, it may see all of a radial or thrust load or a combination of both. In an embodiment, bearing cartridge 240 may join motor 200 to a structure feature. Bearing cartridge 240 may function to minimize the structural impact from the transfer of bearing loads during flight and/or to increase energy efficiency and power of propulsor. Bearing cartridge 240 may include a shaft and collar arrangement, wherein a shaft affixed into a collar assembly. A bearing element may support the two joined structures by reducing transmission of vibration from such bearings. Roller (rolling-contact) bearings are conventionally used for locating and supporting machine parts such as rotors or rotating shafts. Typically, the rolling elements of a roller bearing are balls or rollers. In general, a roller bearing is a is type of anti-friction bearing; a roller bearing functions to reduce friction allowing free rotation. Also, a roller bearing may act to transfer loads between rotating and stationary members. In an embodiment, bearing cartridge 240 may act to keep propulsor 104 and components intact during flight by allowing motor 200 to rotate freely while resisting loads such as an axial force. In an embodiment, bearing cartridge 240 may include a roller bearing incorporated into the bore. a roller bearing is in contact with rotor shaft 236. Stator 204 may be mechanically coupled to inverter housing. Mechanically coupled may include a mechanical fastening, without limitation, such as nuts, bolts or other fastening device. Mechanically coupled may include welding or casting or the like. Inverter housing may contain a bore which allows insertion by rotor shaft 236 into bearing cartridge 240.

Still referring to FIG. 2, motor 200 may include a motor assembly incorporating a rotating assembly and a stationary assembly. Hub 124, motor inner magnet carrier 224 and rotor shaft 236 may be incorporated into the rotor assembly of motor 200 which make up rotating parts of electric motor, moving between the stator poles and transmitting the motor power. As one integrated part, the rotor assembly may be inserted and removed in one piece. Stator 204 may be incorporated into the stationary part of the motor assembly. Stator and rotor may combine to form an electric motor. In embodiment, an electric motor may, for instance, incorporate coils of wire, which may be similar to or the same as any of the electrically conductive components in the entirety of this disclosure, which are driven by the magnetic force exerted by a first magnetic field on an electric current. The function of the motor may be to convert electrical energy into mechanical energy. In operation, a wire carrying current may create at least a first magnetic field with magnetic poles in a first orientation which interacts with a second magnetic field with magnetic poles oriented in the opposite direction of the first magnetic pole direction causing a force that may move a rotor in a direction. For example, and without limitation, first magnetic element 208 in motor 200 may include an active magnet. For instance, and without limitation, a second magnetic element may include a passive magnet, a magnet that reacts to a magnetic force generated by first magnetic element 208. In an embodiment, a first magnet positioned around the rotor assembly, may generate magnetic fields to affect the position of the rotor relative to the stator 204. A controller may have an ability to adjust electricity originating from a power supply and, thereby, the magnetic forces generated, to ensure stable rotation of the rotor, independent of the forces induced by the machinery process.

Motor 200 may include impeller 244, coupled with the rotor shaft 236. An impeller, as described herein, is a rotor used to increase or decrease the pressure and flow of a fluid, including at least air. Impeller 244 may function to provide cooling to motor 200. Impeller 244 may include varying blade configurations, such as radial blades, non-radial blades, semi-circular blades and airfoil blades. Impeller 244 may further include single and/or double-sided configurations. Impeller 244 is described in further detail below. Additionally, or alternatively, in a non-limiting illustrative example, rotor shaft 236 may be mechanically coupled to cooling vanes. Cooling vanes are used to lower the temperature of a high-velocity mechanical part, like the rotor in an electrical motor. Cooling vanes may employ a plurality of physical principles to cool mechanical parts. Cooling vanes may draw cool air like a fan if mechanically coupled to the rotor at an angle sufficient to create a pressure differential in order to draw cool air from outside the motor housing into the relatively hot inner motor and cool internal mechanical parts by convection. The cooling vanes may alternatively or additionally cool other components disclosed herein with the impeller. Convection cooling in principle, is cooling of a portion of a body by moving a fluid over it, the tendency of heat energy to move from high to low energy areas, like a hot spinning rotor to cool moving air. Additionally, cooling vanes may act as thermodynamic fins. Heat energy may be conducted through the cooling vanes from the hot rotor shaft to the tips of the cooling vanes, thus dissipating heat in a high-speed rotating part. Cooling vanes may be consistent with those disclosed in U.S. patent application Ser. No. 16/910,255 entitled “Integrated Electric Propulsion Assembly” and incorporated herein by reference in its entirety.

Now referring to FIG. 3, an exemplary embodiment of an aircraft 300 is illustrated. Aircraft 300 may include motor 200 may be mounted on a structural feature of an aircraft. Design of motor 200 may enable it to be installed external to the structural member (such as a boom, nacelle, or fuselage) for easy maintenance access and to minimize accessibility requirements for the structure. This may improve structural efficiency by requiring fewer large holes in the mounting area. This design may include two main holes in the top and bottom of the mounting area to access bearing cartridge. Further, a structural feature may include a component of aircraft 300. For example, and without limitation structural feature may be any portion of a vehicle incorporating motor 200, including any vehicle as described below. As a further non-limiting example, a structural feature may include without limitation a wing, a spar, an outrigger, a fuselage, or any portion thereof; persons skilled in the art, upon reviewing the entirety of this disclosure, will be aware of many possible features that may function as at least a structural feature. At least a structural feature may be constructed of any suitable material or combination of materials, including without limitation metal such as aluminum, titanium, steel, or the like, polymer materials or composites, fiberglass, carbon fiber, wood, or any other suitable material. As a non-limiting example, at least a structural feature may be constructed from additively manufactured polymer material with a carbon fiber exterior; aluminum parts or other elements may be enclosed for structural strength, or for purposes of supporting, for instance, vibration, torque or shear stresses imposed by at least propulsor 104. Persons skilled in the art, upon reviewing the entirety of this disclosure, will be aware of various materials, combinations of materials, and/or constructions techniques.

Still referring to FIG. 3, aircraft 300 may include a vertical takeoff and landing aircraft (eVTOL). As used herein, a vertical take-off and landing (eVTOL) aircraft is one that can hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

With continued reference to FIG. 3, a number of aerodynamic forces may act upon the aircraft 300 during flight. Forces acting on aircraft 300 during flight may include, without limitation, thrust, the forward force produced by the rotating element of the aircraft 300 and acts parallel to the longitudinal axis. Another force acting upon aircraft 300 may be, without limitation, drag, which may be defined as a rearward retarding force which is caused by disruption of airflow by any protruding surface of the aircraft 300 such as, without limitation, the wing, rotor, and fuselage. Drag may oppose thrust and acts rearward parallel to the relative wind. A further force acting upon aircraft 300 may include, without limitation, weight, which may include a combined load of the aircraft 300 itself, crew, baggage, and/or fuel. Weight may pull aircraft 300 downward due to the force of gravity. An additional force acting on aircraft 300 may include, without limitation, lift, which may act to oppose the downward force of weight and may be produced by the dynamic effect of air acting on the airfoil and/or downward thrust from the propulsor 104 of the aircraft. Lift generated by the airfoil may depend on speed of airflow, density of air, total area of an airfoil and/or segment thereof, and/or an angle of attack between air and the airfoil. For example, and without limitation, aircraft 300 are designed to be as lightweight as possible. Reducing the weight of the aircraft and designing to reduce the number of components is essential to optimize the weight. To save energy, it may be useful to reduce weight of components of aircraft 300, including without limitation propulsors and/or propulsion assemblies. In an embodiment, motor 200 may eliminate need for many external structural features that otherwise might be needed to join one component to another component. Motor 200 may also increase energy efficiency by enabling a lower physical propulsor profile, reducing drag and/or wind resistance. This may also increase durability by lessening the extent to which drag and/or wind resistance add to forces acting on aircraft 300 and/or propulsors.

Still referring to FIG. 3, motor 200 may include a stator which has a first magnetic generating element generating a first magnetic field. Motor 200 may also include propulsor 104 with an integrated rotor assembly of the motor assembly which may include a hub mounted to stator, at least a second magnetic element generating a second magnetic field. First magnetic field and second magnetic field vary with respect to time which generates a magnetic force between both causing the rotor assembly to rotate with respect to the stator.

Still referring to FIG. 3, as used in this disclosure a “fuselage” is the main body of an aircraft, or in other words, the entirety of the aircraft except for the cockpit, nose, wings, empennage, nacelles, any and all control surfaces, and generally contains an aircraft's payload. Fuselage 304 may comprise structural elements that physically support the shape and structure of an aircraft. Structural elements may take a plurality of forms, alone or in combination with other types. Structural elements may vary depending on the construction type of aircraft and specifically, the fuselage. Fuselage 304 may comprise a truss structure. A truss structure is often used with a lightweight aircraft and includes welded steel tube trusses. A truss, as used herein, is an assembly of beams that create a rigid structure, often in combinations of triangles to create three-dimensional shapes. A truss structure may alternatively comprise wood construction in place of steel tubes, or a combination thereof. In embodiments, structural elements may comprise steel tubes and/or wood beams. In an embodiment, and without limitation, structural elements may include an aircraft skin. Aircraft skin may be layered over the body shape constructed by trusses. Aircraft skin may comprise a plurality of materials such as plywood sheets, aluminum, fiberglass, and/or carbon fiber, the latter of which will be addressed in greater detail later in this paper.

In embodiments, fuselage 304 may comprise geodesic construction. Geodesic structural elements may include stringers wound about formers (which may be alternatively called station frames) in opposing spiral directions. A stringer, as used herein, is a general structural element that includes a long, thin, and rigid strip of metal or wood that is mechanically coupled to and spans the distance from, station frame to station frame to create an internal skeleton on which to mechanically couple aircraft skin. A former (or station frame) can include a rigid structural element that is disposed along the length of the interior of fuselage 304 orthogonal to the longitudinal (nose to tail) axis of the aircraft and forms the general shape of fuselage 304. A former may comprise differing cross-sectional shapes at differing locations along fuselage 304, as the former is the structural element that informs the overall shape of a fuselage 304 curvature. In embodiments, aircraft skin can be anchored to formers and strings such that the outer mold line of the volume encapsulated by the formers and stringers includes the same shape as aircraft when installed. In other words, former(s) may form a fuselage's ribs, and the stringers may form the interstitials between such ribs. The spiral orientation of stringers about formers provides uniform robustness at any point on an aircraft fuselage such that if a portion sustains damage, another portion may remain largely unaffected. Aircraft skin would be mechanically coupled to underlying stringers and formers and may interact with a fluid, such as air, to generate lift and perform maneuvers.

In an embodiment, and still referring to FIG. 3, fuselage 304 may comprise monocoque construction. Monocoque construction may include a primary structure that forms a shell (or skin in an aircraft's case) and supports physical loads. Monocoque fuselages are fuselages in which the aircraft skin or shell is also the primary structure. In monocoque construction aircraft skin would support tensile and compressive loads within itself and true monocoque aircraft can be further characterized by the absence of internal structural elements. Aircraft skin in this construction method is rigid and can sustain its shape with no structural assistance form underlying skeleton-like elements. Monocoque fuselage may comprise aircraft skin made from plywood layered in varying grain directions, epoxy-impregnated fiberglass, carbon fiber, or any combination thereof.

Still referring to FIG. 3, fuselage 304 may include a semi-monocoque construction. Semi-monocoque construction, as used herein, is a partial monocoque construction, wherein a monocoque construction is describe above detail. In semi-monocoque construction, fuselage 304 may derive some structural support from stressed aircraft skin and some structural support from underlying frame structure made of structural elements. Formers or station frames can be seen running transverse to the long axis of fuselage 304 with circular cutouts which are generally used in real-world manufacturing for weight savings and for the routing of electrical harnesses and other modern on-board systems. In a semi-monocoque construction, stringers are the thin, long strips of material that run parallel to fuselage's long axis. Stringers may be mechanically coupled to formers permanently, such as with rivets. Aircraft skin may be mechanically coupled to stringers and formers permanently, such as by rivets as well. A person of ordinary skill in the art will appreciate that there are numerous methods for mechanical fastening of the aforementioned components like crews, nails, dowels, pins, anchors, adhesives like glue or epoxy, or bolts and nuts, to name a few. A subset of fuselage under the umbrella of semi-monocoque construction is unibody vehicles. Unibody, which is short for “unitized body” or alternatively “unitary construction”, vehicles are characterized by a construction in which the body, floor plan, and chassis form a single structure. In the aircraft world, unibody would comprise the internal structural elements like formers and stringers are constructed in one piece, integral to the aircraft skin as well as any floor construction like a deck.

Still referring to FIG. 3, it should be noted that an illustrative embodiment is presented only, and this disclosure in no way limits the form or construction of aircraft. In embodiments, fuselage 304 may be configurable based on the needs of the electric per specific mission or objective. The general arrangement of components, structural elements, and hardware associated with storing and/or moving a payload may be added or removed from fuselage 304 as needed, whether it is stowed manually, automatedly, or removed by personnel altogether. Fuselage 304 may be configurable for a plurality of storage options. Bulkheads and dividers may be installed and uninstalled as needed, as well as longitudinal dividers where necessary. Bulkheads and dividers may be installed using integrated slots and hooks, tabs, boss and channel, or hardware like bolts, nuts, screws, nails, clips, pins, and/or dowels, to name a few. Fuselage 304 may also be configurable to accept certain specific cargo containers, or a receptable that can, in turn, accept certain cargo containers.

Still referring to FIG. 3, aircraft includes at least a laterally extending element 308, wherein the at least a laterally extending element is attached to fuselage 304. As used in this disclosure a “laterally extending element” is an element that projects essentially horizontally from fuselage, including an outrigger, a spar, and/or a fixed wing that extends from fuselage. Laterally extending element 308 projects laterally from fuselage 304. Wings may be structures which include airfoils configured to create a pressure differential resulting in lift. Wings may generally dispose on the left and right sides of the aircraft symmetrically, at a point between nose and empennage. Wings may comprise a plurality of geometries in planform view, swept swing, tapered, variable wing, triangular, oblong, elliptical, square, among others. A wing's cross section may geometry includes an airfoil. Wing may include a leading edge. For example, and without limitation, leading edge may include one or more edges that may comprise one or more characteristics such as sweep, radius and/or stagnation point, droop, thermal effects, and the like thereof. In an embodiment, and without limitation, wing may include a trailing edge. In an embodiment, and without limitation, trailing edge may include an edge capable of controlling the direction of the departing medium from the wing,

such that a controlling force is exerted on the aircraft. Laterally extending element 208 may comprise differing and/or similar cross-sectional geometries over its cord length or the length from wing tip to where wing meets the aircraft's body. One or more wings may be symmetrical about the aircraft's longitudinal plane, which includes the longitudinal or roll axis reaching down the center of the aircraft through the nose and empennage, and the plane's yaw axis. Laterally extending element 308 may comprise control surfaces configured to be commanded by a pilot or pilots to change a wing's geometry and therefore its interaction with a fluid medium, like air. Control surfaces may comprise flaps, ailerons, tabs, spoilers, slats, and the like.

With continued reference to FIG. 3, aircraft 300 includes a plurality of propulsors. Each of the plurality of propulsors may be consistent with propulsor 104 discussed with reference to FIG. 1. The plurality of propulsors may include, in some embodiments, two propulsors, four propulsors, eight propulsors, or more than eight propulsors, for example in a distributed propulsion configuration. In some embodiments, plurality of propulsors may include an odd number of propulsors such as three or five. One of ordinary skill in the art, after having reviewed the entirety of this disclosure, would appreciate that plurality of propulsors may include a variety of numbers of propulsors in a variety of configurations.

With continued reference to FIG. 3, plurality of propulsors may include a first propulsor 312, second propulsor 316, third propulsor 320, and fourth propulsor 324. Each of the plurality of propulsors may be communicatively connected to a controller as discussed in this disclosure. Each of the plurality of propulsors may also include a braking module as previously discussed in this disclosure.

With continued reference to FIG. 3, in some embodiments, first propulsor 312 and third propulsor 320 may be front propulsors. A “front propulsor,” for the purposes of this disclosure, is a propulsor located in front of laterally extending element 308. In some embodiments, second propulsor 316 and fourth propulsor 324 may be a rear propulsor. A “rear propulsor,” for the purposes of this disclosure, is a propulsor located behind laterally extending element 308. “In front” and “behind” are defined with reference to the orientation shown in FIG. 3.

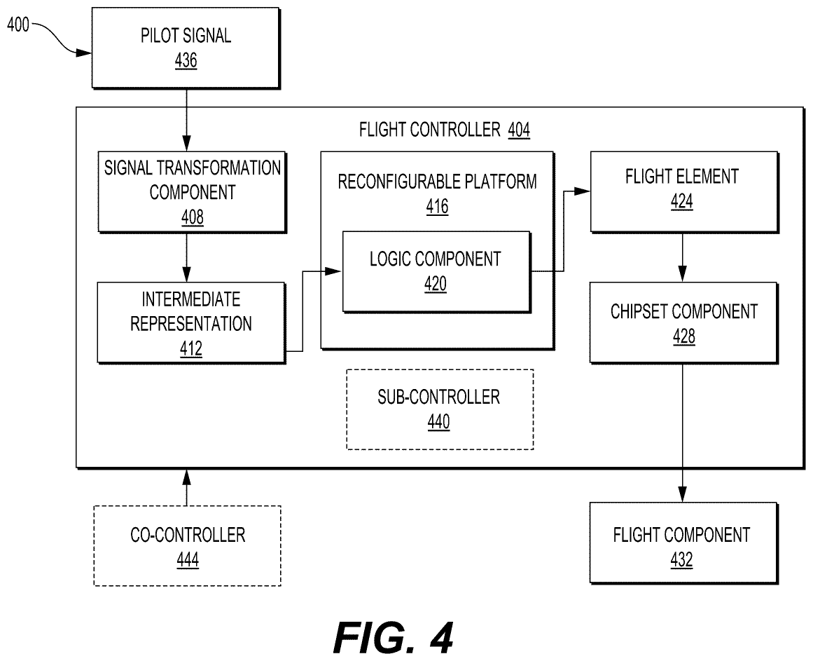

Now referring to FIG. 4, an exemplary embodiment 400 of a flight controller 404 is illustrated. As used in this disclosure a “flight controller” is a computing device of a plurality of computing devices dedicated to data storage, security, distribution of traffic for load balancing, and flight instruction. Flight controller 404 may include and/or communicate with any computing device as described in this disclosure, including without limitation a microcontroller, microprocessor, digital signal processor (DSP) and/or system on a chip (SoC) as described in this disclosure. Further, flight controller 404 may include a single computing device operating independently, or may include two or more computing device operating in concert, in parallel, sequentially or the like; two or more computing devices may be included together in a single computing device or in two or more computing devices. In embodiments, flight controller 404 may be installed in an aircraft, may control the aircraft remotely, and/or may include an element installed in the aircraft and a remote element in communication therewith.

In an embodiment, and still referring to FIG. 4, flight controller 404 may include a signal transformation component 408. As used in this disclosure a “signal transformation component” is a component that transforms and/or converts a first signal to a second signal, wherein a signal may include one or more digital and/or analog signals. For example, and without limitation, signal transformation component 408 may be configured to perform one or more operations such as preprocessing, lexical analysis, parsing, semantic analysis, and the like thereof. In an embodiment, and without limitation, signal transformation component 408 may include one or more analog-to-digital convertors that transform a first signal of an analog signal to a second signal of a digital signal. For example, and without limitation, an analog-to-digital converter may convert an analog input signal to a 10-bit binary digital representation of that signal. In another embodiment, signal transformation component 408 may include transforming one or more low-level languages such as, but not limited to, machine languages and/or assembly languages. For example, and without limitation, signal transformation component 408 may include transforming a binary language signal to an assembly language signal. In an embodiment, and without limitation, signal transformation component 408 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 4, signal transformation component 408 may be configured to optimize an intermediate representation 412. As used in this disclosure an “intermediate representation” is a data structure and/or code that represents the input signal. Signal transformation component 408 may optimize intermediate representation as a function of a data-flow analysis, dependence analysis, alias analysis, pointer analysis, escape analysis, and the like thereof. In an embodiment, and without limitation, signal transformation component 408 may optimize intermediate representation 412 as a function of one or more inline expansions, dead code eliminations, constant propagation, loop transformations, and/or automatic parallelization functions. In another embodiment, signal transformation component 408 may optimize intermediate representation as a function of a machine dependent optimization such as a peephole optimization, wherein a peephole optimization may rewrite short sequences of code into more efficient sequences of code. Signal transformation component 408 may optimize intermediate representation to generate an output language, wherein an “output language,” as used herein, is the native machine language of flight controller 404. For example, and without limitation, native machine language may include one or more binary and/or numerical languages.

In an embodiment, and without limitation, signal transformation component 408 may include transform one or more inputs and outputs as a function of an error correction code. An error correction code, also known as error correcting code

(ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q−k−l)/2 erroneous symbols.

Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

In an embodiment, and still referring to FIG. 4, flight controller 404 may include a reconfigurable hardware platform 416. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform 416 may be reconfigured to enact any algorithm and/or algorithm selection process received from another computing device and/or created using machine-learning processes.

Still referring to FIG. 4, reconfigurable hardware platform 416 may include a logic component 420. As used in this disclosure a “logic component” is a component that executes instructions on output language. For example, and without limitation, logic component may perform basic arithmetic, logic, controlling, input/output operations, and the like thereof. Logic component 420 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 420 may be organized according to Von Neumann and/or Harvard architecture as a non-limiting example. Logic component 420 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC). In an embodiment, logic component 420 may include one or more integrated circuit microprocessors, which may contain one or more central processing units, central processors, and/or main processors, on a single metal-oxide-semiconductor chip. Logic component 420 may be configured to execute a sequence of stored instructions to be performed on the output language and/or intermediate representation 412. Logic component 420 may be configured to fetch and/or retrieve the instruction from a memory cache, wherein a “memory cache,” as used in this disclosure, is a stored instruction set on flight controller 404. Logic component 420 may be configured to decode the instruction retrieved from the memory cache to opcodes and/or operands. Logic component 420 may be configured to execute the instruction on intermediate representation 412 and/or output language. For example, and without limitation, logic component 420 may be configured to execute an addition operation on intermediate representation 412 and/or output language.

In an embodiment, and without limitation, logic component 420 may be configured to calculate a flight element 424. As used in this disclosure a “flight element” is an element of datum denoting a relative status of aircraft. For example, and without limitation, flight element 424 may denote one or more torques, thrusts, airspeed velocities, forces, altitudes, groundspeed velocities, directions during flight, directions facing, forces, orientations, and the like thereof. For example, and without limitation, flight element 424 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 424 may denote that aircraft is following a flight path accurately and/or sufficiently.

Still referring to FIG. 4, flight controller 404 may include a chipset component 428. As used in this disclosure a “chipset component” is a component that manages data flow. In an embodiment, and without limitation, chipset component 428 may include a northbridge data flow path, wherein the northbridge dataflow path may manage data flow from logic component 420 to a high-speed device and/or component, such as a RAM, graphics controller, and the like thereof. In another embodiment, and without limitation, chipset component 428 may include a southbridge data flow path, wherein the southbridge dataflow path may manage data flow from logic component 420 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 428 may manage data flow between logic component 420, memory cache, and a flight component 432. As used in this disclosure a “flight component” is a portion of an aircraft that can be moved or adjusted to affect one or more flight elements. For example, flight component 432 may include a component used to affect the aircrafts' roll and pitch which may comprise one or more ailerons. As a further example, flight component 432 may include a rudder to control yaw of an aircraft. In an embodiment, chipset component 428 may be configured to communicate with a plurality of flight components as a function of flight element 424. For example, and without limitation, chipset component 428 may transmit to an aircraft rotor to reduce torque of a first lift propulsor and increase the forward thrust produced by a pusher component to perform a flight maneuver.

In an embodiment, and still referring to FIG. 4, flight controller 404 may be configured generate an autonomous function. As used in this disclosure an “autonomous function” is a mode and/or function of flight controller 404 that controls aircraft automatically. For example, and without limitation, autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 424. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 404 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 404 will control the ailerons and/or rudders. As used in this disclosure “non-autonomous mode” is a mode that denotes a pilot will control aircraft and/or maneuvers of aircraft in its entirety.

In an embodiment, and still referring to FIG. 4, flight controller 404 may generate autonomous function as a function of an autonomous machine-learning model. As used in this disclosure an “autonomous machine-learning model” is a machine-learning model to produce an autonomous function output given flight element 424 and a pilot signal 436 as inputs; this is in contrast to a non-machine learning software program where the commands to be executed are determined in advance by a user and written in a programming language. As used in this disclosure a “pilot signal” is an element of datum representing one or more functions a pilot is controlling and/or adjusting. For example, pilot signal 436 may denote that a pilot is controlling and/or maneuvering ailerons, wherein the pilot is not in control of the rudders and/or propulsors. In an embodiment, pilot signal 436 may include an implicit signal and/or an explicit signal. For example, and without limitation, pilot signal 436 may include an explicit signal, wherein the pilot explicitly states there is a lack of control and/or desire for autonomous function. As a further non-limiting example, pilot signal 436 may include an explicit signal directing flight controller 404 to control and/or maintain a portion of aircraft, a portion of the flight plan, the entire aircraft, and/or the entire flight plan. As a further non-limiting example, pilot signal 436 may include an implicit signal, wherein flight controller 404 detects a lack of control such as by a malfunction, torque alteration, flight path deviation, and the like thereof. In an embodiment, and without limitation, pilot signal 436 may include one or more explicit signals to reduce torque, and/or one or more implicit signals that torque may be reduced due to reduction of airspeed velocity. In an embodiment, and without limitation, pilot signal 436 may include one or more local and/or global signals. For example, and without limitation, pilot signal 436 may include a local signal that is transmitted by a pilot and/or crew member. As a further non-limiting example, pilot signal 436 may include a global signal that is transmitted by air traffic control and/or one or more remote users that are in communication with the pilot of aircraft. In an embodiment, pilot signal 436 may be received as a function of a tri-state bus and/or multiplexor that denotes an explicit pilot signal should be transmitted prior to any implicit or global pilot signal.

Still referring to FIG. 4, autonomous machine-learning model may include one or more autonomous machine-learning processes such as supervised, unsupervised, or reinforcement machine-learning processes that flight controller 404 and/or a remote device may or may not use in the generation of autonomous function. As used in this disclosure “remote device” is an external device to flight controller 404. Additionally or alternatively, autonomous machine-learning model may include one or more autonomous machine-learning processes that a field-programmable gate array (FPGA) may or may not use in the generation of autonomous function. Autonomous machine-learning process may include, without limitation machine learning processes such as simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naïve bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

In an embodiment, and still referring to FIG. 4, autonomous machine learning model may be trained as a function of autonomous training data, wherein autonomous training data may correlate a flight element, pilot signal, and/or simulation data to an autonomous function. For example, and without limitation, a flight element of an airspeed velocity, a pilot signal of limited and/or no control of propulsors, and a simulation data of required airspeed velocity to reach the destination may result in an autonomous function that includes a semi-autonomous mode to increase thrust of the propulsors. Autonomous training data may be received as a function of user-entered valuations of flight elements, pilot signals, simulation data, and/or autonomous functions. Flight controller 404 may receive autonomous training data by receiving correlations of flight element, pilot signal, and/or simulation data to an autonomous function that were previously received and/or determined during a previous iteration of generation of autonomous function. Autonomous training data may be received by one or more remote devices and/or FPGAs that at least correlate a flight element, pilot signal, and/or simulation data to an autonomous function. Autonomous training data may be received in the form of one or more user-entered correlations of a flight element, pilot signal, and/or simulation data to an autonomous function.

Still referring to FIG. 4, flight controller 404 may receive autonomous machine-learning model from a remote device and/or FPGA that utilizes one or more autonomous machine learning processes, wherein a remote device and an FPGA is described above in detail. For example, and without limitation, a remote device may include a computing device, external device, processor, FPGA, microprocessor and the like thereof. Remote device and/or FPGA may perform the autonomous machine-learning process using autonomous training data to generate autonomous function and transmit the output to flight controller 404. Remote device and/or FPGA may transmit a signal, bit, datum, or parameter to flight controller 404 that at least relates to autonomous function.

Additionally or alternatively, the remote device and/or FPGA may provide an updated machine-learning model. For example, and without limitation, an updated machine-learning model may be comprised of a firmware update, a software update, an autonomous machine-learning process correction, and the like thereof. As a non-limiting example, a software update may incorporate a new simulation data that relates to a modified flight element. Additionally or alternatively, the updated machine learning model may be transmitted to the remote device and/or FPGA, wherein the remote device and/or FPGA may replace the autonomous machine-learning model with the updated machine-learning model and generate the autonomous function as a function of the flight element, pilot signal, and/or simulation data using the updated machine-learning model. The updated machine-learning model may be transmitted by the remote device and/or FPGA and received by flight controller 404 as a software update, firmware update, or corrected autonomous machine-learning model. For example, and without limitation autonomous machine learning model may utilize a neural net machine-learning process, wherein the updated machine-learning model may incorporate a gradient boosting machine-learning process.

Still referring to FIG. 4, flight controller 404 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices.

Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 4, flight controller 404 may include, but is not limited to, for example, a cluster of flight controllers in a first location and a second flight controller or cluster of flight controllers in a second location. Flight controller 404 may include one or more flight controllers dedicated to data storage, security, distribution of traffic for load balancing, and the like. Flight controller 404 may be configured to distribute one or more computing tasks as described below across a plurality of flight controllers, which may operate in parallel, in series, redundantly, or in any other manner used for distribution of tasks or memory between computing devices. For example, and without limitation, flight controller 404 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by MathWorks, Natick, Massachusetts, USA In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

In an embodiment, and still referring to FIG. 4, control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 432. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 4, the plurality of flight controllers may include a master bus controller. As used in this disclosure a “master bus controller” is one or more devices and/or components that are connected to a bus to initiate a direct memory access transaction, wherein a bus is one or more terminals in a bus architecture. Master bus controller may communicate using synchronous and/or asynchronous bus control protocols. In an embodiment, master bus controller may include flight controller 404. In another embodiment, master bus controller may include one or more universal asynchronous receiver-transmitters (UART). For example, and without limitation, master bus controller may include one or more bus architectures that allow a bus to initiate a direct memory access transaction from one or more buses in the bus architectures. As a further non-limiting example, master bus controller may include one or more peripheral devices and/or components to communicate with another peripheral device and/or component and/or the master bus controller. In an embodiment, master bus controller may be configured to perform bus arbitration.

As used in this disclosure “bus arbitration” is method and/or scheme to prevent multiple buses from attempting to communicate with and/or connect to master bus controller. For example and without limitation, bus arbitration may include one or more schemes such as a small computer interface system, wherein a small computer interface system is a set of standards for physical connecting and transferring data between peripheral devices and master bus controller by defining commands, protocols, electrical, optical, and/or logical interfaces. In an embodiment, master bus controller may receive intermediate representation 412 and/or output language from logic component 420, wherein output language may include one or more analog-to-digital conversions, low bit rate transmissions, message encryptions, digital signals, binary signals, logic signals, analog signals, and the like thereof described above in detail.

Still referring to FIG. 4, master bus controller may communicate with a slave bus. As used in this disclosure a “slave bus” is one or more peripheral devices and/or components that initiate a bus transfer. For example, and without limitation, slave bus may receive one or more controls and/or asymmetric communications from master bus controller, wherein slave bus transfers data stored to master bus controller. In an embodiment, and without limitation, slave bus may include one or more internal buses, such as but not limited to a/an internal data bus, memory bus, system bus, front-side bus, and the like thereof. In another embodiment, and without limitation, slave bus may include one or more external buses such as external flight controllers, external computers, remote devices, printers, aircraft computer systems, flight control systems, and the like thereof.

In an embodiment, and still referring to FIG. 4, control algorithm may optimize signal communication as a function of determining one or more discrete timings. For example, and without limitation master bus controller may synchronize timing of the segmented control algorithm by injecting high priority timing signals on a bus of the master bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 4, flight controller 404 may also be implemented using a “shared nothing” architecture in which data is cached at the worker, in an embodiment, this may enable scalability of aircraft and/or computing device. Flight controller 404 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers. In an embodiment, distributed flight control may include one or more neural networks. For example, neural network also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, a node may include, without limitation a plurality of inputs Xi that may receive numerical values from inputs to a neural network containing the node and/or from other nodes. Node may perform a weighted sum of inputs using weights Wi that are multiplied by respective inputs Xi. Additionally or alternatively, a bias b may be added to the weighted sum of the inputs such that an offset is added to each unit in the neural network layer that is independent of the input to the layer. The weighted sum may then be input into a function (f), which may generate one or more outputs y. Weight Wi applied to an input Xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights Wi may be determined by training a neural network using training data, which may be performed using any suitable process as described above. In an embodiment, and without limitation, a neural network may receive semantic units as inputs and output vectors representing such semantic units according to weights Wi that are derived using machine-learning processes as described in this disclosure.

Still referring to FIG. 4, flight controller may include a sub-controller 440. As used in this disclosure a “sub-controller” is a controller and/or component that is part of a distributed controller as described above; for instance, flight controller 404 may be and/or include a distributed flight controller made up of one or more sub-controllers. For example, and without limitation, sub-controller 440 may include any controllers and/or components thereof that are similar to distributed flight controller and/or flight controller as described above. Sub-controller 440 may include any component of any flight controller as described above. Sub-controller 440 may be implemented in any manner suitable for implementation of a flight controller as described above. As a further non-limiting example, sub-controller 440 may include one or more processors, logic components and/or computing devices capable of receiving, processing, and/or transmitting data across the distributed flight controller as described above. As a further non-limiting example, sub-controller 440 may include a controller that receives a signal from a first flight controller and/or first distributed flight controller component and transmits the signal to a plurality of additional sub-controllers and/or flight components.

Still referring to FIG. 4, flight controller may include a co-controller 444. As used in this disclosure a “co-controller” is a controller and/or component that joins flight controller 404 as components and/or nodes of a distributer flight controller as described above. For example, and without limitation, co-controller 444 may include one or more controllers and/or components that are similar to flight controller 404. As a further non-limiting example, co-controller 444 may include any controller and/or component that joins flight controller 404 to distributer flight controller. As a further non-limiting example, co-controller 444 may include one or more processors, logic components and/or computing devices capable of receiving, processing, and/or transmitting data to and/or from flight controller 404 to distributed flight control system. Co-controller 444 may include any component of any flight controller as described above. Co-controller 444 may be implemented in any manner suitable for implementation of a flight controller as described above.

In an embodiment, and with continued reference to FIG. 4, flight controller 404 may be designed and/or configured to perform any method, method step, or sequence of method steps in any embodiment described in this disclosure, in any order and with any degree of repetition. For instance, flight controller 404 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing. Referring now to FIG. 5, an exemplary embodiment of a machine-learning module 500 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 504 to generate an algorithm that will be performed by a computing device/module to produce outputs 508 given data provided as inputs 512; this is in contrast to a non-machine learning software program where the commands to be executed are determined in advance by a user and written in a programming language.

Still referring to FIG. 5, “training data,” as used herein, is data containing correlations that a machine-learning process may use to model relationships between two or more categories of data elements. For instance, and without limitation, training data 504 may include a plurality of data entries, each entry representing a set of data elements that were recorded, received, and/or generated together; data elements may be correlated by shared existence in a given data entry, by proximity in a given data entry, or the like. Multiple data entries in training data 504 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 504 according to various correlations; correlations may indicate causative and/or predictive links between categories of data elements, which may be modeled as relationships such as mathematical relationships by machine-learning processes as described in further detail below. Training data 504 may be formatted and/or organized by categories of data elements, for instance by associating data elements with one or more descriptors corresponding to categories of data elements. As a non-limiting example, training data 504 may include data entered in standardized forms by persons or processes, such that entry of a given data element in a given field in a form may be mapped to one or more descriptors of categories. Elements in training data 504 may be linked to descriptors of categories by tags, tokens, or other data elements; for instance, and without limitation, training data 504 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 5, training data 504 may include one or more elements that are not categorized; that is, training data 504 may not be formatted or contain descriptors for some elements of data. Machine-learning algorithms and/or other processes may sort training data 504 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 504 to be made applicable for two or more distinct machine-learning algorithms as described in further detail below. Training data 504 used by machine-learning module 500 may correlate any input data as described in this disclosure to any output data as described in this disclosure. As a non-limiting illustrative example flight elements and/or pilot signals may be inputs, wherein an output may be an autonomous function.

Further referring to FIG. 5, training data may be filtered, sorted, and/or selected using one or more supervised and/or unsupervised machine-learning processes and/or models as described in further detail below; such models may include without limitation a training data classifier 516. Training data classifier 516 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 500 may generate a classifier using a classification algorithm, defined as a processes whereby a computing device and/or any module and/or component operating thereon derives a classifier from training data 504. Classification may be performed using, without limitation, linear classifiers such as without limitation logistic regression and/or naïve Bayes classifiers, nearest neighbor classifiers such ask-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 516 may classify elements of training data to sub-categories of flight elements such as torques, forces, thrusts, directions, and the like thereof.

Still referring to FIG. 5, machine-learning module 500 may be configured to perform a lazy-learning process 520 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 504. Heuristic may include selecting some number of highest-ranking associations and/or training data 504 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 5, machine-learning processes as described in this disclosure may be used to generate machine-learning models 524. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 524 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 524 may be generated by creating an artificial neural network, such as a convolutional neural network comprising an input layer of nodes, one or more intermediate layers, and an output layer of nodes. Connections between nodes may be created via the process of “training” the network, in which elements from a training data 504 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 5, machine-learning algorithms may include at least a supervised machine-learning process 528. At least a supervised machine-learning process 528, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include flight elements and/or pilot signals as described above as inputs, autonomous functions as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 504. Persons skilled in the art, upon reviewing the entirety of this disclosure, will be aware of various possible variations of at least a supervised machine-learning process 528 that may be used to determine relation between inputs and outputs. Supervised machine-learning processes may include classification algorithms as defined above.

Further referring to FIG. 5, machine learning processes may include at least an unsupervised machine-learning processes 532. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 5, machine-learning module 500 may be designed and configured to create a machine-learning model 524 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure.

Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 5, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

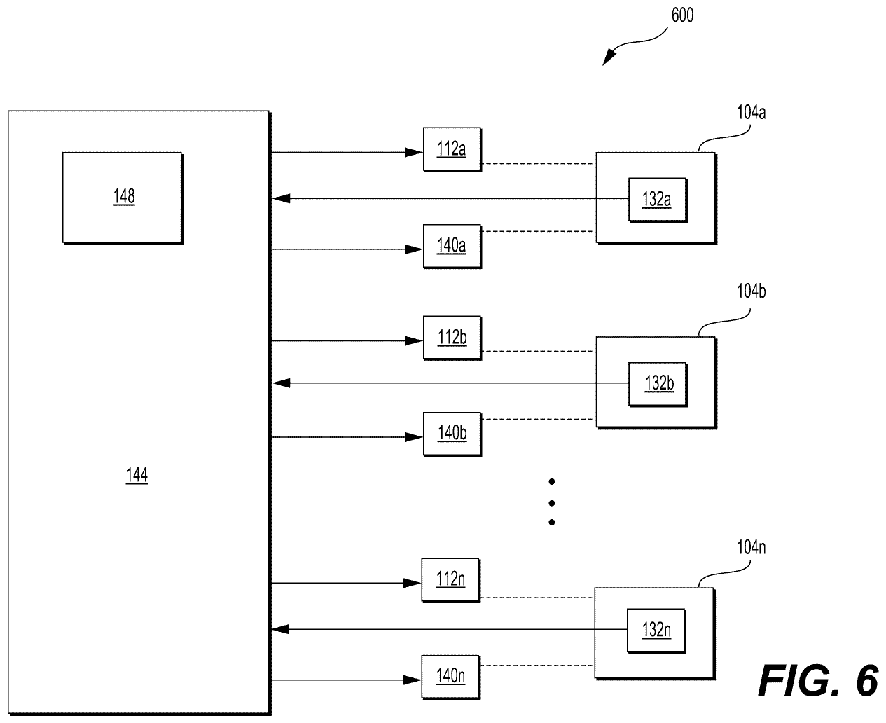

Referring now to FIG. 6, control system 600 is illustrated. Control system 600 may include controller 144, propulsor(s) 104a-n, propulsor sensor(s) 132a-n, motor(s) 112a-n, and braking module 140. Control system 600 may be a subsystem of system 100. As previously discussed, deceleration of propulsor 104 may be based on machine-learning module 148. Controller 144 may be communicatively connected to sensors 132a-n. Additionally, controller 144 may be communicatively connected to motor 112, propulsor 104, and/or braking module 140.

With continued reference to FIG. 6, controller 144 may receive signals from propulsor sensors 132a-n based on measured motion parameters of one or more corresponding propulsors 104a-n and/or corresponding motor(s) 112a-n. For example, the signals may include the position of the blades of propulsors 104a-n, the angular velocity of propulsors 104a-n, the change in position of the blades of propulsors 104a-n, the speed of the blades of propulsors 104a-n, and the like. In some examples, the signals may include rate of rotation of the motor 112, an angle or orientation of the motor 112, the rate of rotation of the propulsor, and/or any other measurable element.

With continued reference to FIG. 6, propulsor sensors 132a-n may measure one or more motion parameter for each propulsor 104a-n and/or each motor 112a-n, respectively. For example, where there is a first propulsor (e.g. first propulsor 312 in FIG. 3), the associated propulsor sensor(s) 132 may measure one or more first motion parameters associated with the first propulsor and/or a motor. Where there is a second propulsor (e.g. second propulsor 316 in FIG. 3), the associated propulsor sensor(s) 132a-n may measure one or more second motion parameter(s) associated with the second propulsor and/or second motor. Third motion parameter(s) associated with a third propulsor and/or third motor and fourth motion parameter(s) associated with a fourth propulsor and/or fourth motor may be measured similarly. Controller 144 may control an amount of torque applied by motors 112a-n to propulsors 104a-n and/or an amount of force, such as friction, applied by braking modules 140a-n to the propulsors 104a-n based on the corresponding signals the controller 144 receives from sensors 132a-n. The signal that controller 144 may receive from sensors 132a-n may include a motion parameter from the associated propulsor 104a-n.

Still referring to FIG. 6, controller 144 may be configured to control motion of each propulsor 104a-n and/or motor 112. For example, controller 144 may be configured to control the motion of first propulsor 312, second propulsor 316, third propulsor 320, and/or fourth propulsor 324 as discussed with reference to FIG. 3. Controller 144 may control a position and/or rotational rate of each propulsor 104a-n by controlling a torque applied to each of the propulsors 104a-n from corresponding motors 112a-n and/or by controlling braking applied to each of the propulsors 104a-n, such as by braking module 140a-n. Controller 144 may control phase relationships between rotational rate of two or more of propulsors 104a-n. In some embodiments, system 100 may include a propeller synchrophaser, which controller 144 may control, to control speed of propulsors 104a-n rotation and/or phase relationship between two or more propulsors 104a-n. Controller 144 may be configured to eliminate drumming or beating of propulsors 104a-n caused by slightly different rotational rates of propulsors 104a-n by adjusting the propulsors 104a-n to have the same rotational rates. Controller 144 may be configured to synchronously decelerate each propulsor 104a-n based on at least a motion detected by propulsor sensors 132a-n, such as first motion parameter, second motion parameter, third motion parameter, and/or fourth motion parameter discussed above. As used in this disclosure, “synchronously decelerate” means reduce a rate of rotation of more than one propulsor simultaneously. In some embodiments, controller 144 may be configured to synchronously decelerate each propulsor 104a-n such that all propulsors 104a-n decelerate at the same rate simultaneously.

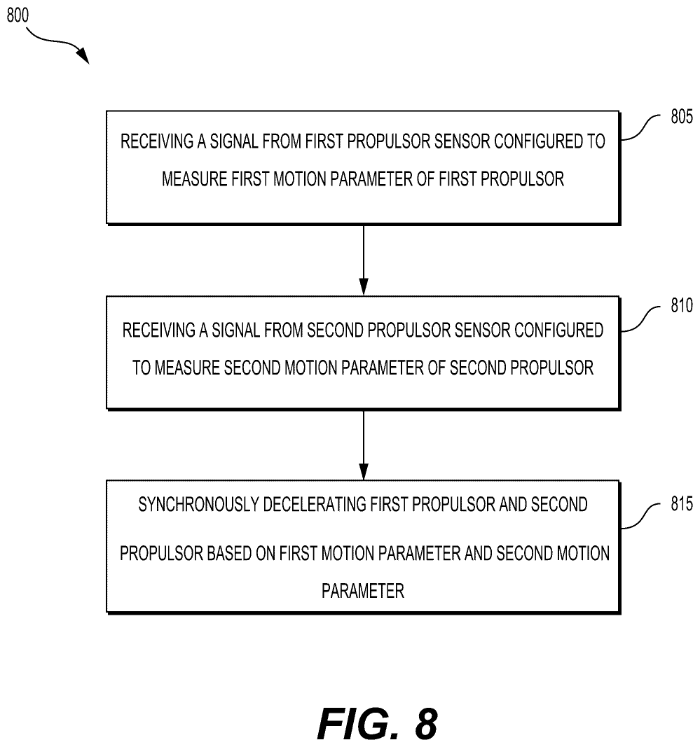

With continued reference to FIG. 6, Controller 144 may utilize braking modules 144a-n and/or motors 112a-n to synchronously or asynchronously decelerate one or more of the plurality of propulsors 104a-n, as discussed above. Controller 144 may control braking module 140a-n and/or motor 112a-n as function of signal from propulsor sensors 132a-n. With continued reference to FIG. 6, an amount of force applied to propulsor 104a-n by the respective electronic brake of braking module 140a-n may be based on a trajectory (e.g., velocity trajectory and/or position trajectory) of propulsor 104. Trajectories are discussed further with reference to FIGS. 7A, 7B, and 8. In some embodiments, electronic brake may be configured to apply a constant force to propulsor 104. While electronic brake applies a constant force to a propulsor 104, the braking may be selectively overcome by torque from a respective motor 112. For example, this may be done to match the velocity trajectory of propulsor 104. Controller 144 may be configured to control an amount of braking from braking modules 140a-n applied to propulsors 104a-n and an amount of torque applied to the propulsors 104a-n from motor 112a-n to control a resulting deceleration rate of the propulsor 104a-n. In some embodiments, controller 144 may allow force from braking module 140a-n to gradually overcome torque from motor 112a-n to gradually decelerate propulsor 104a-n. Controller 144 may determine an amount of force to be applied to propulsor 104a-n by braking module 140a-n and/or an amount of torque to be applied to the propulsor 104a-n by motor 112a-n based on one or more tables including an amount of braking force and/or an amount of torque to be applied to the propulsor 104 to achieve a given deceleration rate.

With continued reference to FIG. 6, controller 144 may be configured to control motor(s) 112a-n as a function of signal from propulsor sensor 132a-n. Controlling motor 112a-n may include allowing propulsor 104a-n to slow at a desired rate, based on trajectories 700A and 700B described in FIGS. 7A and 7B below, for parking when the aircraft is parked. As used in this disclosure, “parked” is a state of an aircraft that is grounded, stationary, and its propulsors are not in use. For the purposes of this disclosure, blades of propulsor 104a-n are “parked” when they are stationary and not in use. Controller 144 may be configured to control a parked position of each propulsor 104a-n and/or each motor 112a-n, such as a parked position for blades of each propulsor 104a-n and/or an orientation or angle of each motor 112a-n. In some embodiments, including embodiments in which there are two blades per propulsor 104a-n, controller 144 may park blades such that the blades positioned front to rear or aircraft. Controller 144 may be configured to control a deceleration of a rate of rotation of propulsor 104a-n by gradually reducing an amount of power provided to the propulsor(s) 104a-n by motor(s) 112a-n. For example, if a pilot inputs in controls a command to stop powering one or more propulsor(s) 104a-n, controller 144 may gradually reduce the power provided to the one or more propulsor(s) 104a-n according to a trajectory (e.g., such as trajectories 700A and/or 700B) to control a rate of deceleration of the one or more propulsor(s) 104a-n.

In an example, controller 144 may determine an amount of power to provide to propulsor 104a-n based on signal from at least a propulsor sensor 132a-n, such that controller 144 may increase an amount of power to the propulsor 104a-n if the deceleration is too high and controller 144 may further decrease the amount of power to the propulsor 104a-n if the deceleration is too low.

In some embodiments, controller 144 may be configured to control a deceleration of a rate of rotation of propulsor 104a-n by controlling braking module 140a-n. Similar to the above, if a pilot inputs in controls a command to stop powering propulsor 104a-n, controller 144 may gradually engage braking module 140a-n. For example, controller 144 may gradually extend the plunger from the coil, causing second braking pad to press against first braking pad. Controller 144 may control the amount of pressure between first braking pad and second braking pad based on signal from at least a propulsor sensor 132a-n to control a rate of deceleration of propulsor 104a-n. Controller 144 may increase an amount of pressure between first braking pad and second braking pad if the deceleration is too high and controller 144 may further decrease pressure between first braking pad and second braking pad if the deceleration is too low. A rate of deceleration of propulsor 104a-n may be based on one or more predetermined rates, such as on optimate rate of deceleration, an optimal range of rates of deceleration, and/or a threshold deceleration. As used in this disclosure, a “threshold deceleration” is a predetermined rate of deceleration of a propulsor 104a-n that a deceleration of a rotation of the propulsor 104a-n should not exceed. Controller 144 may be configured to engage and disengage braking module 140a-n based on signal from propulsor sensor 132a-n.

For example, controller 144 may be configured to disengage braking module 140a-n when rotor 120 is rotating. Controller 144 may be configured to stop an application of switching at stator when braking module 140a-n is engaged and propulsor 104a-n is parked. For synchronously decelerating plurality of propulsors 104, controller 144 may decelerate the propulsors 104 according to a predetermined deceleration rate. In some embodiments, synchronously decelerating propulsors 104 may include each motor 112a-n applying an equal torque to each corresponding propulsor 104a-n. Controller 144 may also apply unequal torques to propulsors 104. If controller 144 receives a signal from propulsor sensor 132a-n that reflects the propulsor 104a-n is decelerating at a rate above the predetermined deceleration rate, then controller 144 may reduce the amount of force, such as friction, braking module 140a-n is applying to the propulsor 104a-n and/or apply torque to the propulsor 104a-n from motor 112a-n. If controller 144 receives a signal from propulsor sensor 132a-n that reflects the propulsor 104a-n is decelerating at a rate below the predetermined deceleration rate, then controller 144 may increase the amount of force braking module 140a-n is applying to the propulsor 104a-n.

In some embodiments, controller 144 may be configured to adjust a length of time that propulsors 104 decelerate to zero by adjusting a deceleration rate. Controller 144 may be configured to decelerate a first group of propulsors at a first rate and a second group of propulsors at a second rate distinct from the first rate. For example, controller 144 may decelerate front propulsors at a first rate and decelerate rear propulsors at a second distinct rate. In some embodiments, rear propulsors may operate at a greater rotational rate than the front propulsors. Controller 144 may decelerate rear propulsors at a greater rate than the controller 144 decelerates front propulsors.

Controller 144 may begin deceleration of front propulsors before or after beginning deceleration of rear propulsors. In some examples, controller 144 may decelerate a first propulsor of the front propulsors at a first rate and a second propulsor of the front propulsors at a second distinct rate. Controller 144 may control braking module 140a-n to apply a constant force on one or more of the propulsor(s) 104a-n. Controller 144 may be configured to decelerate front propulsors and rear propulsors such that the rear propulsors maintain a higher rotational rate than the front propulsors at any given time.

Referring now to FIG. 7A, an exemplary trajectory 700A is illustrated, according to techniques described herein. In some examples, the trajectory 700A may be represented as a type of graph (e.g., exponential, linear, etc.). Trajectory 700A may include a velocity trajectory 702 that is generated by the controller 144 for one or more of the motors. For the purposes of this disclosure, a “velocity trajectory” is a trajectory computed by the controller 144, in real time, that the controller uses to decelerate the motor of a propulsor when it is being spun-down or parked. For instance, the trajectory 700A may represent a reference point for the type of graph or shape of the velocity trajectory 702 that the controller wants to use when commanding the motor to slow down and park. The trajectory 700A may further comprise the velocity of the motor and the integral (e.g., the position) trajectory (described in FIG. 7B below, of the motor, such that the motor can, based on receiving a single control signal, follow the trajectory 700A smoothly to the desired azimuth (e.g., zero velocity and a particular parking position). Thus, position and speed of the motor (and propulsors) may be represented by a single trajectory (e.g., trajectory 700A).

The velocity trajectory 702 may represent the computed trajectory that is based on trajectory 700A. In this case, “velocity” corresponds to both the position and speed of the motor, including the angular velocity. “Angular” velocity may, for example, be measured in revolutions per second, radians per second, degrees per second, revolutions per minute, radians per minute, degrees per minute, and the like. The motors and/or propulsors may decelerate according to the trajectory 700A, resulting in the motors reaching zero velocity and ending in a parked position simultaneously.

In some examples, the trajectory 700A may be determined in response to receiving a signal commanding one or more of the motors to park. The velocity trajectory 702 may comprise any shape (e.g., may be represented by any type of function). In some examples, the shape of the trajectory 700A may be determined and/or preset by a user of the aircraft. Accordingly, when the controller 144 receives a command to park, the controller may determine a shape of the trajectory 700A in order to compute the velocity trajectory 702.

In some examples, the velocity trajectory 702 may be determined based on a desired azimuth 704. The desired azimuth 704 may represent a position (e.g., such as an angle or orientation) of the motor when the motor is in a parked position and when the velocity of the motor is equal to zero. Based on the desired azimuth 704, the controller 144 may determine the starting point 706 of the velocity trajectory 702. Thus, the controller 144 may determine the starting point 706 of the velocity trajectory 702 based on the desired parked position of the motor and/or propulsor. The starting point 706 may also be determined based on one or more motion parameters (e.g., current velocity of the motor, etc.).

For instance, the starting point 706 may represent a starting velocity of the motor, that, when reached, initiates parking of a propulsor according to the trajectory 700A. In some examples, the starting point 706 may be a velocity value that is greater than a current velocity of the motor. Accordingly, the motor may be commanded to increase velocity in order to reach the starting point 706. In other examples, the starting point 706 may be a lower velocity than the current velocity. In this example, a braking torque may be applied to slow the motor down to the starting point 706. Thus, the starting point 706 may be computed such that the unwrapped position of the motor will end at the desired azimuth 704. While the illustrated starting point 706 is shown as “1”, the starting point value may be greater than or less than one. For instance, since the desired azimuth 704 corresponds to the angle or orientation that the motor will be in when in a parked position (as determined by the position trajectory 708 described below), the controller 144 may integrate the velocity trajectory, eventually it will reach some constant value since the velocity goes to zero. In order to make the constant value equal to the desired azimuth value (e.g., based on the integral of the trajectory 700A shape) the controller 144 may determine the starting point 706 (e.g., the initial velocity start point (e.g., 1, 1.1)). For example, where the starting point 706 has a value equal to “1”, results in a different desired azimuth 704 for the position trajectory 708 (discussed below) compared to a starting point 706 with a value of “1.1.” Thus, the controller 144 may determine a starting point 706 the velocity trajectory 702 with a value that is the closest value to the current velocity of the motor when the system is commanded to park, such that the final position trajectory (described in FIG. 7B) of the motor ends at the desired position (e.g., constant value) when the velocity of the motor reaches zero velocity. In some examples, the braking torque applied to a motor and/or propulsor is based on the computed velocity trajectory 702. As noted herein, the controller 144 may determine trajectories for each motor 112a-n and/or each propulsor.

With continued reference to FIG. 7A, trajectory 700A may include a y-axis of velocity and an x-axis of time. Time may be measured in seconds, hours, minutes, and the like. In some embodiments, the velocity and/or time axis may begin at “zero.” In some examples, the trajectory 702 may be generated and/or calculated based on one or more motion parameters. For instance, as noted above, the controller 144 may receive signals from propulsor sensors 132a-n based on measured motion parameters of one or more corresponding propulsors 104a-n and/or one or more of the motors 112a-n. In some examples, the signals may include rate of rotation of the motor 112, an angle or orientation of the motor 112, the rate of rotation of the propulsor, and/or any other measurable element. Accordingly, the trajectory 702 may be calculated based on the azimuth, current velocity of the motor, and/or one or more motion parameters.

With continued reference to FIG. 7A, in some embodiments, a controller, such as controller 144 discussed above, may command a motor to follow the trajectory 700A in order to park a propulsor. In some examples, the controller may, based on the shape of trajectory 700A, determine velocity trajectory 702 and position trajectory 708 described in FIG. 7B below. In some examples, the controller 144 may generate different trajectories for each propulsor and/or motor 112a-n to follow. In some embodiments, controller may also use aircraft parameters and/or other motion parameters to determine the trajectories.

Referring now to FIG. 7B, an exemplary trajectory 700B that may be generated by a controller 144, according to techniques described herein. In some examples, the trajectory 700B may be represented as a graph illustrating orientation vs. time of a motor. For instance, the y-axis illustrated by the trajectory 700B may be unwrapped (e.g., such that it represents a continuous line) verses being constrained to a particular range (e.g., −180 degrees to 180 degrees, etc.). Trajectory 700B may represent a position trajectory 708 that is computed by the controller 144. Position trajectory 708 may be determined based on computing the integral of trajectory 700A and/or velocity trajectory 702. For instance, position trajectory 708 may be determined based on a shape of trajectory 700A and/or based on velocity trajectory 702. As noted herein, the position trajectory 708 may be provided as input to the motor and/or a position controller of the motor and may enable the motor to end in the orientation indicated by the desired azimuth 704 when the velocity of the motor reaches zero velocity. As noted above, the desired azimuth 704 may represent an orientation of the motor 112 in a parked position. Moreover, as described above, the controller 144 may determine the starting point 706 value of the velocity trajectory 702 based on the desired azimuth 704 of the position trajectory 708. Thus, the controller 144 may generate the velocity trajectory 702

With reference to FIGS. 7A and 7B, controller may be configured to decelerate a motor based on the trajectories 700A and 700B. In some examples, the controller may generate a control signal to cause the motor to decelerate according to the trajectories, such that the motor simultaneously follows the velocity trajectory and position trajectory, and ends in the desired parked position when zero velocity is reached. Thus, the controller may generate and send a single control signal to the motor that enables the motor to smoothly and simultaneously control both speed and position of a motor. In some embodiments, controller may decelerate the motor such that it follows, or substantially follows the velocity trajectory 702 and position trajectory 708 simultaneously. In some embodiments, controller may generate trajectories for each motor and/or propulsor, such that each motor may receive a different command. In some embodiments, controller may be configured to generate the trajectories based on the parked position of one or more of the plurality of propulsors and/or one or more of the motors. For example, a parked position of the propulsors may be where one or more of the blades of a propulsor are all in line with the longitudinal axis of the aircraft when the propulsors come to a stop and velocity of the motor is zero. In some embodiments, controller may decelerate one or more of the propulsors using a motor (such as motor 112). In some embodiments, controller may use a braking module 140 to decelerate the motor and/or propulsors. In some embodiments, braking module may be an electronic brake. In some embodiments, the electronic brake may be configured to apply a constant force (such as a braking force) to one or more propulsors of the plurality of propulsors. In these embodiments, controller may synchronously decelerate the plurality of propulsors along the trajectories 700A/700B by applying a positive torque using a motor (such as motor 112), wherein the positive torque is calculated by the controller to partially counteract the constant force applied by the electronic brake, such that the motor and/or propulsor follows the trajectories simultaneously and smoothly.

Thus, the techniques may enable motors to simultaneously control both speed and orientation while parking, such that the motor and/or propulsor reaches a desired parked position at the same time the motor reaches zero velocity. Moreover, the techniques enable the controller 144 to provide a single command signal to a motor that provides both trajectories 700A and 700B, enabling the controller to simultaneously control the speed and position of each motor. That is, unlike existing techniques which may command a motor to slow down and subsequently command the propulsors to park in a particular position, the techniques described herein enable the motor to follow the trajectory 702, such that there is no pausing or disruption between decelerating and stowing of the propulsors.

Referring now to FIG. 8, an embodiment of a method 800 for propulsor synchronization is illustrated. At step 805, controller in aircraft receives signal from first propulsor sensor of plurality of propulsor sensors, the first propulsor sensor configured to measure first motion parameter of first propulsor of plurality of propulsors; this may be implemented, without limitation, as described above in reference to FIGS. 1-7. Propulsor sensor may include a proximity sensor. Signal may be based on a proximity between proximity sensor and proximity sensor target.

At step 810, controller receives signal from second propulsor sensor of plurality of propulsor sensors, the second propulsor sensor configured to measure second motion parameter of second propulsor of plurality of propulsors; this may be implemented, without limitation, as described above in reference to FIGS. 1-7.

At step 815, controller synchronously decelerating first propulsor and second propulsor based on first motion parameter and second motion parameter; this may be implemented, without limitation, as described above in reference to FIGS. 1-7. Controller may be configured to control parked position of plurality of propulsors. In some embodiments, step 815 may include adjusting a length of time in which each propulsor of the plurality of propulsors are to be decelerated to zero propulsor velocity. Decelerating first propulsor and second propulsor may include applying first torque to first propulsor and second torque to second propulsor. First torque may be equal to second torque. First propulsor may be a front propulsor and second propulsor may be a rear propulsor, wherein controller is configured to decelerate the first propulsor at first rate and second propulsor at second rate distinct from the first rate. Synchronously decelerating first propulsor and second propulsor may include decelerating the first propulsor and the second propulsor at same rate.

Synchronously decelerating first propulsor and second propulsor may include adjusting torque applied to first propulsors based on first motion parameter. Synchronously decelerating first propulsor and second propulsor may include utilizing synchrophaser configured to adjust position of each propulsor of plurality of propulsors. Synchronously decelerating first propulsor and second propulsor may include controlling position of first propulsor and a position of second propulsor. In some embodiments, step 815 may include synchronously decelerating the first propulsor and the second propulsor comprises applying an electronic brake to each of the first propulsor and the second propulsor. In some embodiments, step 815 may include calculating a first trajectory for the first propulsor and a second trajectory for the second propulsor, and applying a positive torque to each of the first propulsor and the second propulsor, wherein the electronic brake is configured to apply a constant force to each of the first propulsor and the second propulsor, and the positive torque is calculated by the controller to partially counteract the constant force applied by the electronic brake, such that first propulsor and the second propulsor synchronously decelerate along their respective velocity trajectories. In some embodiments, step 815 may include calculating a first trajectory (e.g., a first velocity trajectory and a corresponding position trajectory) for the first propulsor, based on the desired parking position of the first propulsor. In some embodiments, step 815 may include calculating a second trajectory (e.g., a second velocity trajectory and a second corresponding position trajectory) for the second propulsor. Step 815 may be implemented, without limitation, as described above in reference to FIGS. 1-7.

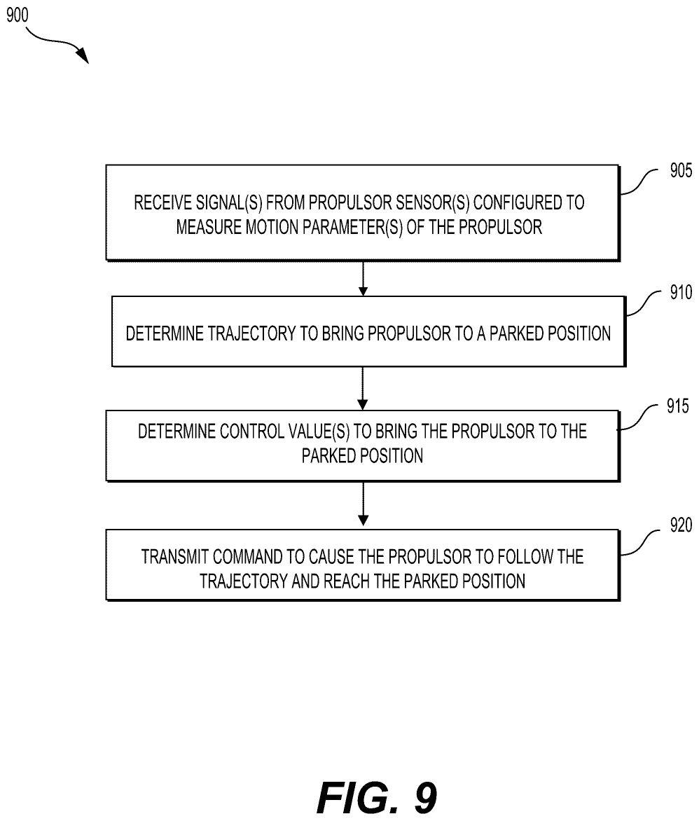

Referring now to FIG. 9, an embodiment of a method 900 for propulsor parking is illustrated. In some examples, one or more of the steps illustrated in FIG. 9 may be performed by one or more computing device(s) (e.g., such as controller 144, motor 112, etc.), as described herein.

At step 905, a controller may receive signal(s) from propulsor sensor(s) configured to measure motion parameter(s) of a propulsor. For instance, controller may correspond to controller 144. The controller 144 may receive a first signal from a first propulsor sensor configured to measure a rate of rotation of the propulsor. The controller 144 may receive a second signal from a second propulsor sensor configured to measure an orientation (e.g., position, angle, etc.) of the propulsor.

At step 910, the controller may determine a trajectory to bring the propulsor to a parked position. For instance, the trajectory may be based on a predetermined trajectory shape. In some examples, prior to determining the trajectory the controller is further configured to determine the ending orientation associated with the parked position of the propulsor, wherein determining the trajectory is further based on the ending orientation.

The trajectory may comprise a velocity trajectory and a position trajectory. In some examples, the trajectory may correspond to decelerating the rate of rotation of the propulsor to zero velocity and bringing the orientation of the propulsor to an ending orientation associated with the parked position. For instance, the ending orientation may correspond to an angle of the propulsor or a position of one or more blades of the propulsor.

At step 915, controller may determine control value(s) to bring the propulsor to the parked position. In some examples, determining the control values comprises utilizing a synchrophaser configured to adjust a position of the propulsor. In some examples, determining the control values comprises determining an initial velocity of the propulsor that, when reached, causes the propulsor to follow the trajectory. In some examples, the initial velocity may correspond to starting point 706. In some examples, determining the initial velocity of the propulsor is based on the ending orientation of the propulsor in the parked position.

In some examples, determining the control values further comprises: determining a velocity trajectory of the propulsor; and determining, based on the velocity trajectory, a position trajectory of the propulsor, wherein the command comprises instructions to cause a velocity controller to apply the velocity trajectory and a position controller of the propulsor to follow the position trajectory to the ending orientation.

At step 920, controller may transmit a command to cause the propulsor to follow the trajectory and reach the parked position. For instance, the command may comprise a control signal configured to cause the propulsor to implement the trajectory by simultaneously decelerating the rate of rotation of the propulsor to zero velocity and cause the propulsor to be oriented according to the ending orientation at the parked position. In some examples, the command further comprises instructions to cause the propulsor to increase or decrease the rate of rotation to equal the initial velocity. In some examples, the command further comprises instructions to apply an electronic brake to the propulsor according to the trajectory. In some examples, the command includes the velocity trajectory and/or the position trajectory. In some examples, the controller is further configured to determine different trajectories for each propulsor of the aircraft.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

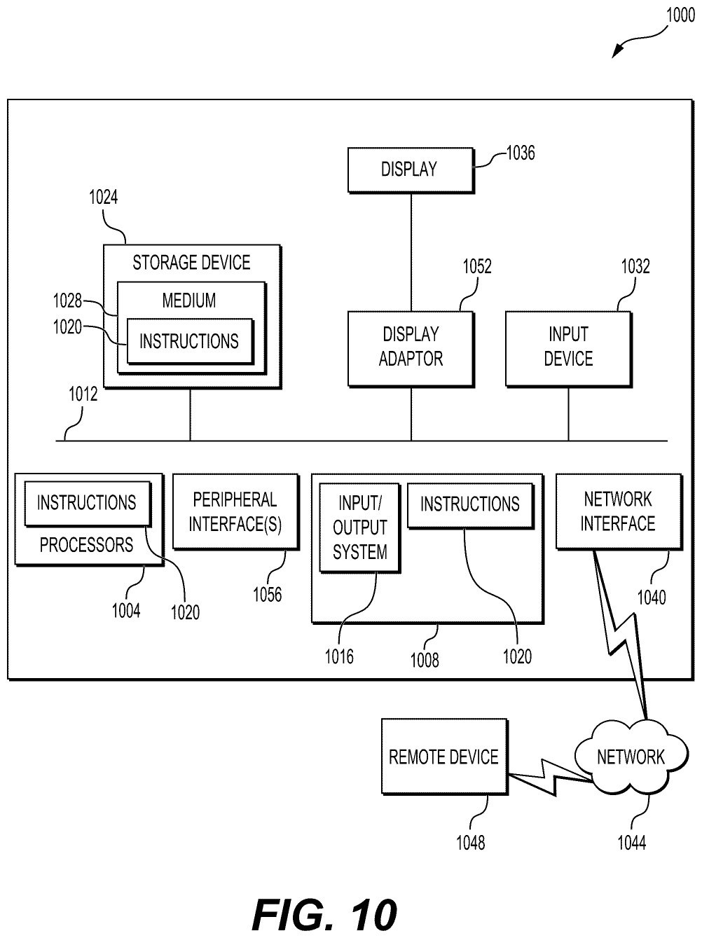

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display device 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof.

Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods and systems according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for propulsor parking of an aircraft, comprising:
a controller configured to:
receive a first signal from a first propulsor sensor configured to measure a rate of rotation of a propulsor;
receive a second signal from a second propulsor sensor configured to measure an orientation of the propulsor;
determine a trajectory associated with bringing the propulsor to a parked position, the trajectory corresponding to decelerating the rate of rotation of the propulsor to zero velocity and bringing the orientation of the propulsor to an ending orientation associated with the parked position;
determine, based at least on the trajectory, control values to cause the propulsor to reach the parked position; and
transmit a command to the propulsor, wherein the command is configured to cause the propulsor to implement the trajectory by simultaneously decelerating the rate of rotation of the propulsor to zero velocity and cause the propulsor to be oriented according to the ending orientation at the parked position.

2. The system of claim 1, wherein prior to determining the trajectory the controller is further configured to determine the ending orientation associated with the parked position of the propulsor, wherein determining the trajectory is further based on the ending orientation.

3. The system of claim 1, wherein the command further comprises instructions to apply an electronic brake to the propulsor according to the trajectory.

4. The system of claim 1, wherein determining the control values comprises utilizing a synchrophaser configured to adjust a position of the propulsor.

5. The system of claim 1, wherein determining the control values comprises determining an initial velocity of the propulsor that, when reached, causes the propulsor to follow the trajectory.

6. The system of claim 5, wherein the command further comprises instructions to cause the propulsor to increase or decrease the rate of rotation to equal the initial velocity.

7. The system of claim 5, wherein determining the initial velocity of the propulsor is based on the ending orientation of the propulsor in the parked position.

8. The system of claim 1, wherein determining the control values further comprises:
determining a velocity trajectory of the propulsor; and
determining, based on the velocity trajectory, a position trajectory of the propulsor, wherein the command comprises instructions to cause a velocity controller to apply the velocity trajectory and a position controller of the propulsor to follow the position trajectory to the ending orientation.

9. The system of claim 1, wherein the controller is further configured to determine different trajectories for each propulsor of the aircraft.

10. The system of claim 1, wherein the ending orientation corresponds to an angle of the propulsor or a position of one or more blades of the propulsor.

11. A method for parking propulsors of an aircraft, the method comprising:
receiving, by a controller, a first signal from a first propulsor sensor configured to measure a rate of rotation of a propulsor;
receiving, by the controller, a second signal from a second propulsor sensor configured to measure an orientation of the propulsor;
determining, by the controller, a trajectory to bring the propulsor to a parked position, the trajectory corresponding to decelerating the rate of rotation of the propulsor to zero velocity and bringing the orientation of the propulsor to an ending orientation associated with the parked position;
determining, based at least on the trajectory, control values to cause the propulsor to reach the parked position; and
transmitting, by the controller, a command to the propulsor, wherein the command is configured to cause the propulsor to implement the trajectory by simultaneously decelerating the rate of rotation of the propulsor to zero velocity and causing the propulsor to be oriented according to the ending orientation at the parked position.

12. The method of claim 11, wherein prior to determining the trajectory the method further comprises determining the ending orientation associated with the parked position of the propulsor, wherein determining the trajectory is further based on the ending orientation.

13. The method of claim 11, wherein the command further comprises instructions to apply an electronic brake to the propulsor according to the trajectory.

14. The method of claim 11, wherein determining the control values comprises utilizing a synchrophaser configured to adjust a position of the propulsor.

15. The method of claim 11, wherein determining the control values comprises determining an initial velocity of the propulsor that, when reached, causes the propulsor to follow the trajectory.

16. The method of claim 15, wherein the command further comprises instructions to cause the propulsor to increase or decrease the rate of rotation to equal the initial velocity.

17. The method of claim 15, wherein determining the initial velocity of the propulsor is based on the ending orientation of the propulsor in the parked position.

18. The method of claim 11, wherein determining the control values further comprises:
determining a velocity trajectory of the propulsor; and
determining, based on the velocity trajectory, a position trajectory of the propulsor, wherein the command comprises instructions to cause a velocity controller to apply the velocity trajectory and a position controller of the propulsor to follow the position trajectory to the ending orientation.

19. The method of claim 11, further comprising determining a plurality of different trajectories for a plurality of propulsors of the aircraft.

20. The method of claim 11, wherein the ending orientation corresponds to an angle of the propulsor or a position of one or more blades of the propulsor.
